(19) United States
(12) Patent Application Publication
(10) Pub. No.: US 2023/0396298 A1
(43) Pub. Date: Dec. 7, 2023

(54) METHOD, USER EQUIPMENT, PROCESSING DEVICE, STORAGE MEDIUM AND COMPUTER PROGRAM FOR TRANSMITTING CHANNEL STATE INFORMATION REPORT, AND METHOD AND BASE STATION FOR RECEIVING CHANNEL STATE INFORMATION REPORT

(71) Applicant: LG ELECTRONICS INC., Seoul (KR)

(72) Inventors: Duckhyun BAE, Seoul (KR); Suckchel YANG, Seoul (KR); Jiwon KANG, Seoul (KR); Haewook PARK, Seoul (KR)

(21) Appl. No.: 18/033,040

(22) PCT Filed: Oct. 22, 2021
(86) PCT No.: PCT/KR2021/014904

§ 371 Date: Apr. 20, 2023

Related U.S. Application Data
(60) Provisional application No. 63/104,459, filed on Oct. 22, 2020.

(51) Int. Cl. H04B 7/06; H04W 72/20; H04L 1/1829

(52) U.S. Cl. CPC H04B 7/0626; H04W 72/20; H04L 1/1854; H04L 1/1861; H04L 1/1812

(57) ABSTRACT

A UE may receive DCI triggering a CSI report; receive a CSI-RS associated with the CSI report; determine a PUCCH resource for the CSI report; and transmit the CSI report on the basis of the PUCCH resource. Determining the PUCCH resource for the CSI report comprises: determining, among periodically allocated PUCCH resources configured for the UE, a PUCCH resource that does not start earlier than time point T+X and time point T′+Y as the PUCCH resource for the CSI report, wherein time point T is the end of the DCI, X is the minimum CSI calculation time from DCI reception, time point T′ is the end of the CSI-RS associated with the CSI report, and Y is the minimum CSI calculation time from CSI-RS reception.

### CROSS-REFERENCE TO RELATED APPLICATIONS

This application is a National Stage filing under 35 U.S.C. 371 of International Application No. PCT/KR2021/014904, filed on Oct. 22, 2021, which claims the benefit of earlier filing date and right of priority to U.S. Provisional Application No. 63/104,459, filed on Oct. 22, 2020, the contents of which are all incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

### SUMMARY

As new radio communication technology has been introduced, the number of UEs to which a BS should provide services in a prescribed resource region is increasing and the volume of data and control information that the BS transmits/receives to/from the UEs to which the BS provides services is also increasing. Since the amount of resources available to the BS for communication with the UE(s) is limited, a new method for the BS to efficiently receive/transmit uplink/downlink data and/or uplink/downlink control information from/to the UE(s) using the limited radio resources is needed. In other words, due to increase in the density of nodes and/or the density of UEs, a method for efficiently using high-density nodes or high-density UEs for communication is needed.

A method to efficiently support various services with different requirements in a wireless communication system is also needed.

Overcoming delay or latency is an important challenge to applications, performance of which is sensitive to delay/latency.

The objects to be achieved with the present disclosure are not limited to what has been particularly described hereinabove and other objects not described herein will be more clearly understood by persons skilled in the art from the following detailed description.

In an aspect of the present disclosure, there is provided a method of transmitting a channel state information (CSI) report by a user equipment (UE) in a wireless communication system. The method may include: receiving downlink control information (DCI) triggering the CSI report; receiving a CSI reference signal (CSI-RS) related to the CSI report; determining a physical uplink control channel (PUCCH) resource for the CSI report; and transmitting the CSI report based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

In another aspect of the present disclosure, there is provided a UE configured to transmit a CSI report in a wireless communication system. The UE may include: at least one transceiver; at least one processor; and at least one computer memory operably connected to the at least one processor and configured to store instructions that, when executed, cause the at least one processor to perform operations. The operations may include: receiving DCI triggering the CSI report; receiving a CSI-RS related to the CSI report; determining a PUCCH resource for the CSI report; and transmitting the CSI report based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

In another aspect of the present disclosure, there is provided a processing device. The processing device may include: at least one processor; and at least one computer memory operably connected to the at least one processor and configured to store instructions that, when executed, cause the at least one processor to perform operations. The operations may include: receiving DCI triggering a CSI report; receiving a CSI-RS related to the CSI report; determining a PUCCH resource for the CSI report; and transmitting the CSI report based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

In another aspect of the present disclosure, there is provided a computer-readable storage medium. The computer-readable storage medium may be configured to store at least one computer program including instructions that, when executed by at least one processor, cause the at least one processor to perform operations for a UE. The operations may include: receiving DCI triggering a CSI report; receiving a CSI-RS related to the CSI report; determining a PUCCH resource for the CSI report; and transmitting the CSI report based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

In another aspect of the present disclosure, there is provided a computer program stored in a computer-readable storage medium. The computer program may include at least one program code including instructions that, when executed, cause at least one processor to perform operations. The operations may include: receiving DCI triggering a CSI report; receiving a CSI-RS related to the CSI report; determining a PUCCH resource for the CSI report; and transmitting the CSI report based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a in time T′ is an end of the CSI-RS related to the CSI report, and Y is a minimum CSI computation time from a CSI-RS reception.

In another aspect of the present disclosure, there is provided a method of receiving, by a base station (BS), a CSI report from a UE in a wireless communication system. The method may include: transmitting DCI triggering the CSI report to the UE; transmitting a CSI-RS related to the CSI report; determining a PUCCH resource for the CSI report; and receiving the CSI report from the UE based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

In a further aspect of the present disclosure, there is provided aBS configured to receive a CSI report from a UE in a wireless communication system. The BS may include: at least one transceiver; at least one processor; and at least one computer memory operably connected to the at least one processor and configured to store instructions that, when executed, cause the at least one processor to perform operations. The operations may include: transmitting DCI triggering the CSI report to the UE; transmitting a CSI-RS related to the CSI report; determining a PUCCH resource for the CSI report; and receiving the CSI report from the UE based on the PUCCH resource. Determining the PUCCH resource for the CSI report may include determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T is an end of the CSI-RS related to the CSI report, and Y is a minimum CSI computation time from a CSI-RS reception.

In each aspect of the present disclosure, the PUCCH resource for the CSI report may be an earliest PUCCH resource occurring after the time T+X and the time T′+Y among PUCCH resources occurring based on a PUCCH resource periodicity and an offset included in a CSI configuration related to the CSI report.

In each aspect of the present disclosure, the CSI report may be an aperiodic CSI report.

In each aspect of the present disclosure, the DCI may be DCI scheduling a physical downlink shared channel (PDSCH).

In each aspect of the present disclosure, the DCI may include a PUCCH resource indicator and a PDSCH-to-HARQ_feedback indicator. Determining the PUCCH resource for the CSI report may include, based on that a first PUCCH resource determined based on the PUCCH resource indicator and the PDSCH-to-HARQ_feedback timing indicator does not start earlier than the time T+X and the time T′+Y, determining the first PUCCH resource as the PUCCH resource for the CSI report. Determining the PUCCH resource for the CSI report may include, based on that the first PUCCH resource starts earlier than the time T+X or the time T′+Y, determining, as the PUCCH resource for the CSI report, a second PUCCH resource occurring after the time T+X and the time T′+Y among the PUCCH resources occurring based on the PUCCH resource periodicity and the offset included in the CSI configuration related to the CSI report.

In each aspect of the present disclosure, the minimum CSI computation time from the CSI-RS reception may be determined based on a CSI type included in the CSI report.

The foregoing solutions are merely a part of the examples of the present disclosure and various examples into which the technical features of the present disclosure are incorporated may be derived and understood by persons skilled in the art from the following detailed description.

According to implementation(s) of the present disclosure, a wireless communication signal may be efficiently transmitted/received. Accordingly, the overall throughput of a wireless communication system may be improved.

According to implementation(s) of the present disclosure, a wireless communication system may efficiently support various services with different requirements.

According to implementation(s) of the present disclosure, delay/latency occurring during wireless communication between communication devices may be reduced.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure;

FIG. 4 illustrates an example of a frame structure used in a 3rd generation partnership project (3GPP)-based wireless communication system;

FIG. 5 illustrates a resource grid of a slot;

FIG. 6 illustrates slot structures used in a 3GPP-based system;

FIG. 7 illustrates an example of PDSCH time domain resource assignment (TDRA) caused by a PDCCH and an example of PUSCH TDRA caused by the PDCCH;

FIG. 8 illustrates a hybrid automatic repeat request-acknowledgement (HARQ-ACK) transmission/reception procedure;

FIG. 9 illustrates an example of multiplexing uplink control information (UCI) with a PUSCH;

FIG. 10 illustrates an example of a process for a UE with overlapping PUCCHs in a single slot to handle collision between UL channels;

FIG. 11 illustrates cases for performing UCI multiplexing based on FIG. 9;

FIG. 12 illustrates a process for a UE with an overlapping PUCCH and PUSCH in a single slot to handle collision between UL channels;

FIG. 13 illustrates UCI multiplexing considering a timeline condition;

FIG. 14 illustrates transmission of a plurality of HARQ-ACK PUCCHs in a slot;

FIG. 15 illustrates a CSI transmission process according to some implementations of the present disclosure;

FIG. 16 illustrates PUCCH resources available for aperiodic CSI triggered by DCI according to some implementations of the present disclosure; and

FIG. 17 illustrates a CSI reception process according to some implementations of the present disclosure.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a node refers to a fixed point capable of transmitting/receiving a radio signal to/from a UE by communication with the UE. Various types of BSs may be used as nodes regardless of the names thereof. For example, a BS, NB, eNB, pico-cell eNB (PeNB), home eNB (HeNB), relay, repeater, etc. may be a node. Furthermore, a node may not be a BS. For example, a radio remote head (RRH) or a radio remote unit (RRU) may be a node. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per node. An antenna may refer to a physical antenna port or refer to a virtual antenna or an antenna group. The node may also be called a point.

In the present disclosure, a cell refers to a specific geographical area in which one or more nodes provide communication services. Accordingly, in the present disclosure, communication with a specific cell may mean communication with a BS or a node providing communication services to the specific cell. A DL/UL signal of the specific cell refers to a DL/UL signal from/to the BS or the node providing communication services to the specific cell. A cell providing UL/DL communication services to a UE is especially called a serving cell. Furthermore, channel status/quality of the specific cell refers to channel status/quality of a channel or a communication link generated between the BS or the node providing communication services to the specific cell and the UE. In 3GPP-based communication systems, the UE may measure a DL channel state from a specific node using cell-specific reference signal(s) (CRS(s)) transmitted on a CRS resource and/or channel state information reference signal(s) (CSI-RS(s)) transmitted on a CSI-RS resource, allocated to the specific node by antenna port(s) of the specific node.

A 3GPP-based communication system uses the concept of a cell in order to manage radio resources, and a cell related with the radio resources is distinguished from a cell of a geographic area.

The “cell” of the geographic area may be understood as coverage within which a node may provide services using a carrier, and the “cell” of the radio resources is associated with bandwidth (BW), which is a frequency range configured by the carrier. Since DL coverage, which is a range within which the node is capable of transmitting a valid signal, and UL coverage, which is a range within which the node is capable of receiving the valid signal from the UE, depend upon a carrier carrying the signal, coverage of the node may also be associated with coverage of the “cell” of radio resources used by the node. Accordingly, the term “cell” may be used to indicate service coverage by the node sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. For example, the combination of the DL resources and the UL resources may be indicated by system information block type 2 (SIB2) linkage. In this case, the carrier frequency may be equal to or different from a center frequency of each cell or CC. When carrier aggregation (CA) is configured, the UE has only one radio resource control (RRC) connection with a network. During RRC connection establishment/re-establishment/handover, one serving cell provides non-access stratum (NAS) mobility information. During RRC connection re-establishment/handover, one serving cell provides security input. This cell is referred to as a primary cell (Pcell). The Pcell refers to a cell operating on a primary frequency on which the UE performs an initial connection establishment procedure or initiates a connection re-establishment procedure. According to UE capability, secondary cells (Scells) may be configured to form a set of serving cells together with the Pcell. The S cell may be configured after completion of RRC connection establishment and used to provide additional radio resources in addition to resources of a specific cell (SpCell). A carrier corresponding to the Pcell on DL is referred to as a downlink primary CC (DL PCC), and a carrier corresponding to the Pcell on UL is referred to as an uplink primary CC (DL PCC). A carrier corresponding to the Scell on DL is referred to as a downlink secondary CC (DL SCC), and a carrier corresponding to the Scell on UL is referred to as an uplink secondary CC (UL SCC).

For dual connectivity (DC) operation, the term SpCell refers to the Pcell of a master cell group (MCG) or the Pcell of a secondary cell group (SCG). The SpCell supports PUCCH transmission and contention-based random access and is always activated. The MCG is a group of service cells associated with a master node (e.g., BS) and includes the SpCell (Pcell) and optionally one or more Scells. For a UE configured with DC, the SCG is a subset of serving cells associated with a secondary node and includes a PSCell and 0 or more Scells. The PSCell is a primary Scell of the SCG. For a UE in RRC_CONNECTED state, not configured with CA or DC, only one serving cell including only the Pcell is present. For a UE in RRC_CONNECTED state, configured with CA or DC, the term serving cells refers to a set of cells including SpCell(s) and all Scell(s). In DC, two medium access control (MAC) entities, i.e., one MAC entity for the MCG and one MAC entity for the SCG, are configured for the UE.

A UE with which CA is configured and DC is not configured may be configured with a Pcell PUCCH group, which includes the Pcell and 0 or more Scells, and an Scell PUCCH group, which includes only Scell(s). For the Scells, an Scell on which a PUCCH associated with the corresponding cell is transmitted (hereinafter, PUCCH cell) may be configured. An Scell indicated as the PUCCH Scell belongs to the Scell PUCCH group and PUCCH transmission of related UCI is performed on the PUCCH Scell. An Scell, which is not indicated as the PUCCH Scell or in which a cell indicated for PUCCH transmission is a Pcell, belongs to the Pcell PUCCH group and PUCCH transmission of related UCI is performed on the Pcell.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, the PDCCH refers to a set of time-frequency resources (e.g., a set of resource elements (REs)) that carry downlink control information (DCI), and the PDSCH refers to a set of time-frequency resources (e.g., a set of REs) that carry DL data. The PUCCH, PUSCH, and PRACH refer to a set of time-frequency resources (i.e., a set of REs) that carry uplink control information (UCI), UL data, and random access signals, respectively. In the following description, the meaning of “The UE transmits/receives the PUCCH/PUSCH/PRACH” is that the UE transmits/receives the UCI/UL data/random access signals on or through the PUCCH/PUSCH/PRACH, respectively. In addition, the meaning of “the BS transmits/receives the PBCH/PDCCH/PDSCH” is that the BS transmits the broadcast information/DCI/DL data on or through a PBCH/PDCCH/PDSCH, respectively.

In the present disclosure, a radio resource (e.g., a time-frequency resource) scheduled or configured for the UE by the BS for transmission or reception of PUCCH/PUSCH/PDSCH is also referred to as a PUCCH/PUSCH/PDSCH resource.

Since a communication device receives an SS/PBCH resource block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, reception of physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

As more and more communication devices have required greater communication capacity, there has been a need for eMBB communication relative to legacy radio access technology (RAT). In addition, massive MTC for providing various services at anytime and anywhere by connecting a plurality of devices and objects to each other is one main issue to be considered in next-generation communication. Further, communication system design considering services/UEs sensitive to reliability and latency is also under discussion. The introduction of next-generation RAT is being discussed in consideration of eMBB communication, massive MTC, ultra-reliable and low-latency communication (URLLC), and the like. Currently, in 3GPP, a study on the next-generation mobile communication systems after EPC is being conducted. In the present disclosure, for convenience, the corresponding technology is referred to a new RAT (NR) or fifth-generation (5G) RAT, and a system using NR or supporting NR is referred to as an NR system.

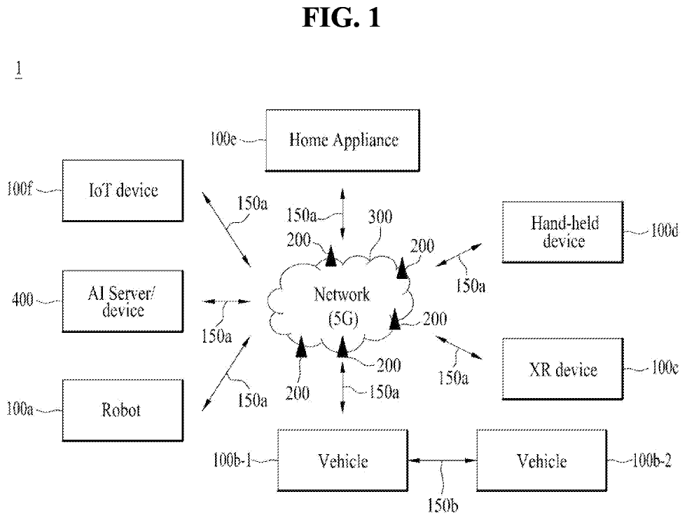

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using RAT (e.g., 5G NR or LTE (e.g., E-UTRA)) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs (e.g., 5G NR). The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

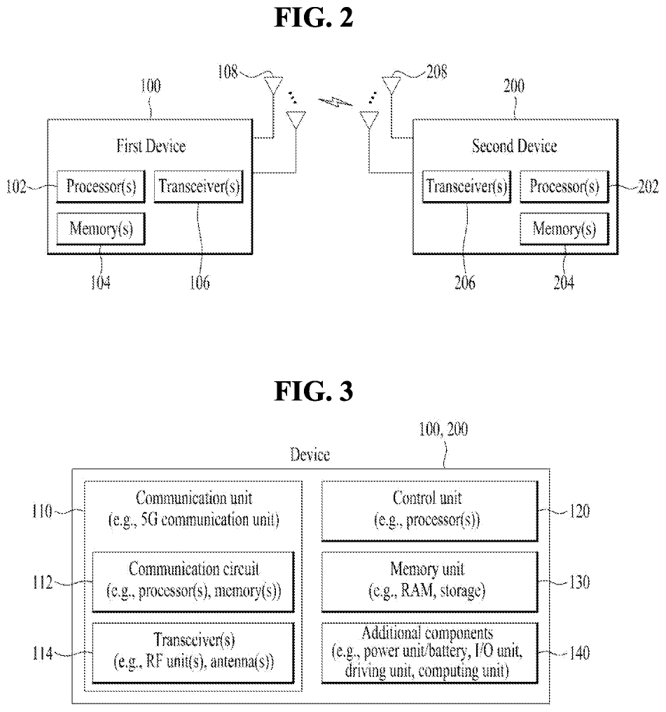

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs (e.g., LTE and NR). Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the afore/below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the afore/below-described/proposed procedures and/or methods. Here, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of Things for low-power communication as well as LTE, NR, and 6G communications. For example, NB-IoT technology may be an example of Low Power Wide Area Network (LPWAN) technology, and may be implemented by, but is limited to, standards such as LTE Cat NB1 and/or LTE Cat NB2. Additionally or alternatively, the wireless communication technology implemented in the wireless devices XXX and YYY of the present disclosure may perform communication based on the LTE-M technology. For example, the LTE-M technology may be an example of the LPWAN technology, and may be called by various names such as enhanced machine type communication (eMTC). For example, the LTE-M technology may be implemented by, but is not limited to, at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M. Additionally or alternatively, the wireless communication technology implemented in the wireless devices XXX and YYY of the present disclosure may include, but is not limited to, at least one of ZigBee, Bluetooth, and Low Power Wide Area Network (LPWAN) considering low-power communication. For example, the ZigBee technology may create personal area networks (PAN) related to small/low-power digital communications based on various standards such as IEEE 802.15.4, and may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in this document. The one or more processors 102 and 202 may generate messages, control information, data, or information according to the functions, procedures, proposals, and/or methods disclosed in this document. The one or more processors 102 and 202 may generate signals (e.g., baseband signals) including PDUs, SDUs, messages, control information, data, or information according to the functions, procedures, proposals, and/or methods disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in this document may be implemented using firmware or software, and the firmware or software may be configured to include the modules, procedures, or functions. Firmware or software configured to perform the functions, procedures, proposals, and/or methods disclosed in this document may be included in the one or more processors 102 and 202 or stored in the one or more memories 104 and 204 so as to be driven by the one or more processors 102 and 202. The functions, procedures, proposals, and/or methods disclosed in this document may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a volatile memory, a non-volatile memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-volatile) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-volatile) storage medium

A communication device of the present disclosure includes at least one processor; and at least one computer memory operably connected to the at least one processor and configured to store instructions for causing, when executed, the at least one processor to perform operations according to example(s) of the present disclosure described later.

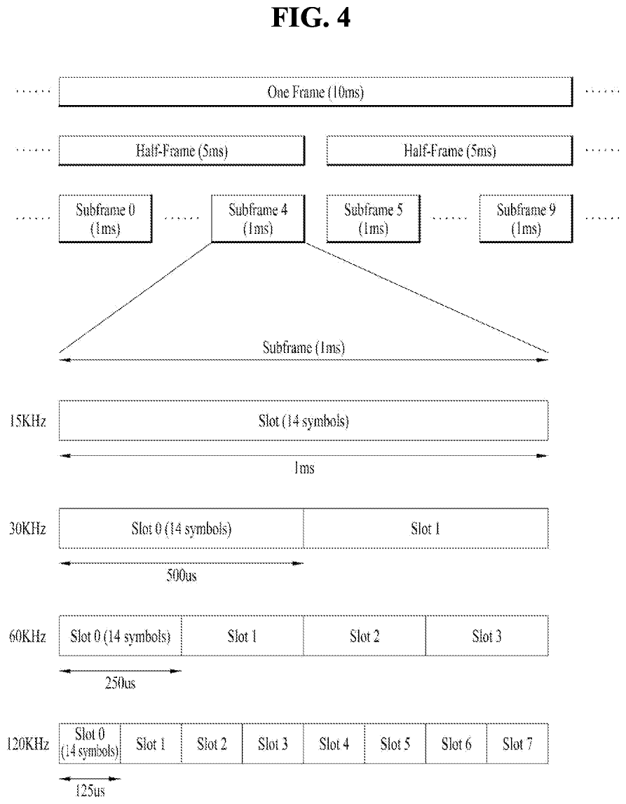

FIG. 4 illustrates an example of a frame structure used in a 3GPP-based wireless communication system.

The frame structure of FIG. 4 is purely exemplary and the number of subframes, the number of slots, and the number of symbols, in a frame, may be variously changed. In an NR system, different OFDM numerologies (e.g., subcarrier spacings (SCSs)) may be configured for multiple cells which are aggregated for one UE. Accordingly, the (absolute time) duration of a time resource including the same number of symbols (e.g., a subframe, a slot, or a transmission time interval (TTI)) may be differently configured for the aggregated cells. Here, the symbol may include an OFDM symbol (or cyclic prefix—OFDM (CP-OFDM) symbol) and an SC-FDMA symbol (or discrete Fourier transform-spread-OFDM (DFT-s-OFDM) symbol). In the present disclosure, the symbol, the OFDM-based symbol, the OFDM symbol, the CP-OFDM symbol, and the DFT-s-OFDM symbol are used interchangeably.

Referring to FIG. 4, in the NR system, UL and DL transmissions are organized into frames. Each frame has a duration of T_{f}=(Δfₘₐₓ*N_{f}/100)*T_{c}=10 ms and is divided into two half-frames of 5 ms each. A basic time unit for NR is T_{c}=1/(Δfₘₐₓ*N_{f}) where Δfₘₐₓ=480*10³ Hz and N_{f}=4096. For reference, a basic time unit for LTE is Tₛ=1/(Δf_{ref}*N_{f,ref}) where Δf_{ref}=15*10³ Hz and N_{f,ref}=2048. T_{c} and T_{f} have the relationship of a constant κ=T_{c}/T_{f}=64. Each half-frame includes 5 subframes and a duration T_{sf} of a single subframe is 1 ms. Subframes are further divided into slots and the number of slots in a subframe depends on a subcarrier spacing. Each slot includes 14 or 12 OFDM symbols based on a cyclic prefix. In a normal CP, each slot includes 14 OFDM symbols and, in an extended CP, each slot includes 12 OFDM symbols. The numerology depends on an exponentially scalable subcarrier spacing Δf=2^{u}*15 kHz. The table below shows the number of OFDM symbols (N^{slot}_{symb}) per slot, the number of slots (N^{frame,u}ₛₗₒₜ) per frame, and the number of slots (N^{subframe,u}ₛₗₒₜ) per subframe.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The table below shows the number of OFDM symbols per slot, the number of slots per frame, and the number of slots per subframe, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

For a subcarrier spacing configuration u, slots may be indexed within a subframe in ascending order as follows: n^{u}ₛ∈{0, . . . , n^{subframe,u}ₛₗₒₜ−1} and indexed within a frame in ascending order as follows: n^{u}_{s,f}∈{0, . . . , n^{frame,u}ₛₗₒₜ−1}.

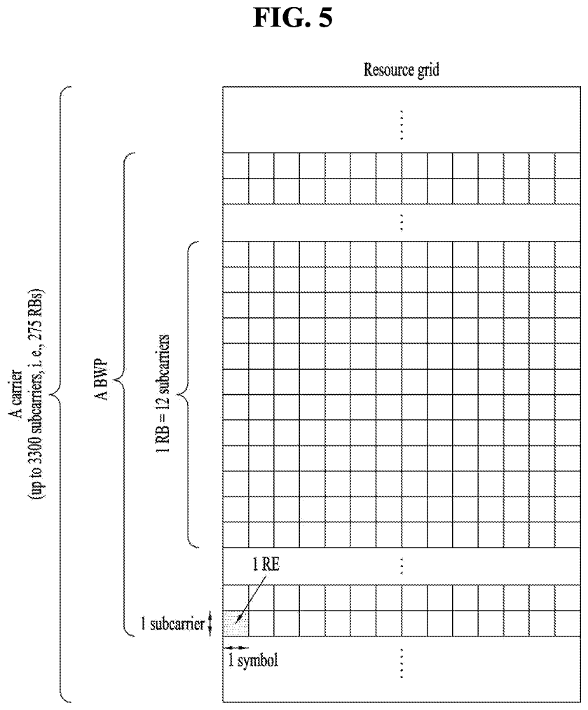

FIG. 5 illustrates a resource grid of a slot. The slot includes multiple (e.g., 14 or 12) symbols in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at a common resource block (CRB) N^{start,u}_{grid} indicated by higher layer signaling (e.g. RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP-based wireless communication system, N^{RB}_{sc} is typically 12. There is one resource grid for a given antenna port p, a subcarrier spacing configuration u, and a transmission link (DL or UL). The carrier bandwidth N^{size,u}_{grid} for the subcarrier spacing configuration u is given to the UE by a higher layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the NR system, an RB is defined by 12 consecutive subcarriers in the frequency domain. In the NR system, RBs are classified into CRBs and physical resource blocks (PRBs). The CRBs are numbered from 0 upwards in the frequency domain for the subcarrier spacing configuration u. The center of subcarrier 0 of CRB 0 for the subcarrier spacing configuration u is equal to ‘Point A’ which serves as a common reference point for RB grids. The PRBs for subcarrier spacing configuration u are defined within a bandwidth part (BWP) and numbered from 0 to N^{size,u}_{BWP,i}−1, where i is a number of the BWP. The relation between a PRB n_{PRB} in a BWP i and a CRB n^{u}_{CRB} is given by: n^{u}_{PRB}=n^{u}_{CRB}+N^{size,u}_{BWP,i}, where N^{size}_{BWP,i} is a CRB in which the BWP starts relative to CRB 0. The BWP includes a plurality of consecutive RBs in the frequency domain. For example, the BWP may be a subset of contiguous CRBs defined for a given numerology uᵢ in the BWP i on a given carrier. A carrier may include a maximum of N (e.g., 5) BWPs. The UE may be configured to have one or more BWPs on a given component carrier. Data communication is performed through an activated BWP and only a predetermined number of BWPs (e.g., one BWP) among BWPs configured for the UE may be active on the component carrier.

For each serving cell in a set of DL BWPs or UL BWPs, the network may configure at least an initial DL BWP and one (if the serving cell is configured with uplink) or two (if supplementary uplink is used) initial UL BWPs. The network may configure additional UL and DL BWPs. For each DL BWP or UL BWP, the UE may be provided with the following parameters for the serving cell: i) an SCS; ii) a CP; iii) a CRB N^{start}_{BWP}=O_{carrier}+RBₛₜₐᵣₜ and the number of contiguous RBs N^{size}_{BWP}=L_{RB} provided by an RRC parameter locationAndBandwidth, which indicates an offset RBₛₑₜ and a length L_{RB} as a resource indicator value (RIV) on the assumption of N^{start}_{BWP}=275, and a value O_{carrier} provided by an RRC parameter offsetToCarrier for the SCS; an index in the set of DL BWPs or UL BWPs; a set of BWP-common parameters; and a set of BWP-dedicated parameters.

Virtual resource blocks (VRBs) may be defined within the BWP and indexed from 0 to N^{size,u}_{BWP,i}−1, where i denotes a BWP number. The VRBs may be mapped to PRBs according to non-interleaved mapping. In some implementations, VRB n may be mapped to PRB n for non-interleaved VRB-to-PRB mapping.

The UE for which carrier aggregation is configured may be configured to use one or more cells. If the UE is configured with a plurality of serving cells, the UE may be configured with one or multiple cell groups. The UE may also be configured with a plurality of cell groups associated with different BSs. Alternatively, the UE may be configured with a plurality of cell groups associated with a single BS. Each cell group of the UE includes one or more serving cells and includes a single PUCCH cell for which PUCCH resources are configured. The PUCCH cell may be a Pcell or an Scell configured as the PUCCH cell among Scells of a corresponding cell group. Each serving cell of the UE belongs to one of cell groups of the UE and does not belong to a plurality of cells.

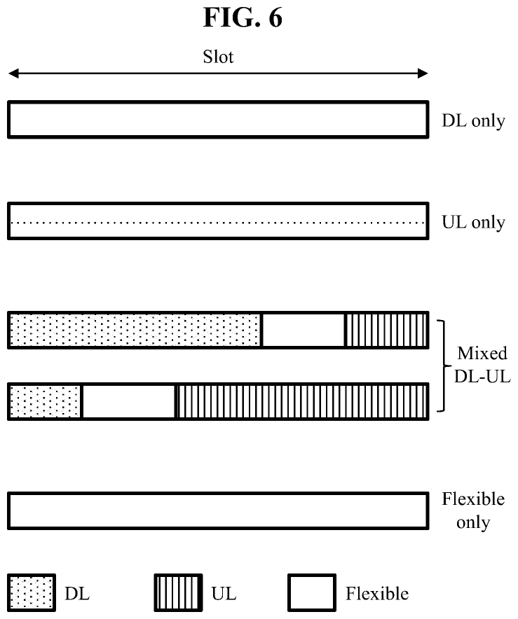

FIG. 6 illustrates slot structures used in a 3GPP-based system. In all 3GPP-based systems, for example, in an NR system, each slot may have a self-contained structure including i) a DL control channel, ii) DL or UL data, and/or iii) a UL control channel. For example, the first N symbols in a slot may be used to transmit the DL control channel (hereinafter, DL control region) and the last M symbols in a slot may be used to transmit the UL control channel (hereinafter, UL control region), where N and M are integers other than negative numbers. A resource region (hereinafter, data region) between the DL control region and the UL control region may be used to transmit DL data or UL data. Symbols in a single slot may be divided into group(s) of consecutive symbols that may be used as DL symbols, UL symbols, or flexible symbols. Hereinbelow, information indicating how each symbol in slot(s) is used will be referred to as a slot format. For example, which symbols in slot(s) are used for UL and which symbols in slot(s) are used for DL may be defined by a slot format.

When a BS intends to operate a serving cell in time division duplex (TDD) mode, the BS may configure a pattern for UL and DL allocation for the serving cell through higher layer (e.g., RRC) signaling. For example, the following parameters may be used to configure a TDD DL-UL pattern:
dl-UL-TransmissionPeriodicity that provides a periodicity of the DL-UL pattern;
nrofDownlinkSlots that provides the number of consecutive full DL slots at the beginning of each DL-UL pattern, where the full DL slots are slots having only DL symbols;
nrofDownlinkSymbols that provides the number of consecutive DL symbols at the beginning of a slot immediately following the last full DL slot;
nrofUplinkSlots that provides the number of consecutive full UL slots at the end of each DL-UL pattern, where the full UL slots are slots having only UL symbols; and
nrofUplinkSymbols that provides the number of consecutive UL symbols in the end of a slot immediately preceding the first full UL slot.

The remaining symbols that are not configured as either DL symbols or UL symbols among symbols in the DL-UL pattern are flexible symbols.

If the UE is provided with a configuration for the TDD DL-UL pattern, i.e., a TDD UL-DL configuration (e.g., tdd-UL-DL-ConfigurationCommon, or tdd-UL-DLConfigurationDedicated), through higher layer signaling, the UE sets a slot format per slot over a number of slots based on the configuration.

For symbols, although there may be various combinations of DL symbols, UL symbols, and flexible symbols, a predetermined number of combinations may be predefined as slot formats and the predefined slot formats may be respectively identified by slot format indexes. The following table shows a part of the predefined slot formats. In the table below, D denotes a DL symbol, U denotes a UL symbol, and F denotes a flexible symbol.

TABLE 3

| For- | Symbol number in a slot | | | | | | | | | | | | | |
|---|---|---|---|---|---|---|---|---|---|---|---|---|---|---|
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |

| | |
|---|---|
| . . . | . . . |

To indicate which slot format is used in a specific slot among the predefined slot formats, the BS may configure a set of slot format combinations applicable to a corresponding serving cell per cell with respect to a set of serving cells through higher layer (e.g., RRC) signaling and cause the UE to monitor a group-common PDCCH for slot format indicator(s) (SFI(s)) through higher layer (e.g., RRC) signaling. Hereinafter, DCI carried by the group-common PDCCH for the SFI(s) will be referred to as SFI DCI. DCI format 2_0 is used as the SFI DCI. For example, for each serving cell in a set of serving cells, the BS may provide the UE with the (start) position of a slot format combination ID (i.e., SFI-index) for a corresponding serving cell in the SFI DCI, a set of slot format combinations applicable to the serving cell, and a reference subcarrier spacing configuration for each slot format in a slot format combination indicated by an SFI-index value in the SFI DCI. One or more slot formats are configured for each slot format combination in the set of the slot format combinations and the slot format combination ID (i.e., SFI-index) is assigned to the slot format combination. For example, when the BS intends to configure the slot format combination with N slot formats, N slot format indexes among slot format indexes for the predefined slot formats (e.g., see Table 3) may be indicated for the slot format combination. In order to configure the UE to monitor the group-common PDCCH for the SFIs, the BS informs the UE of an SFI-RNTI corresponding to a radio network temporary identifier (RNTI) used for an SFI and the total length of a DCI payload scrambled with the SFI-RNTI. Upon detecting the PDCCH based on the SFI-RNTI, the UE may determine slot format(s) for the corresponding serving cell from an SFI-index for the serving cell among SFI-indexes in the DCI payload in the PDCCH.

Symbols indicated as flexible symbols by the TDD DL-UL pattern configuration may be indicated as UL symbols, DL symbols, or flexible symbols by the SFI DCI. Symbols indicated as the DL/UL symbols by the TDD DL-UL pattern configuration are not overridden as the UL/DL symbols or the flexible symbols by the SFI DCI.

If the TDD DL-UL pattern is not configured, the UE determines whether each slot is used for UL or DL and determines symbol allocation in each slot based on the SFI DCI and/or on DCI for scheduling or triggering DL or UL signal transmission (e.g., DCI format 1_0, DCI format 1_1, DCI format 1_2, DCI format 0_0, DCI format 0_1, DCI format 0_2, or DCI format 2_3).

NR frequency bands are defined as two types of frequency ranges, i.e., FR1 and FR2. FR2 is also referred to as millimeter wave (mmW). The following table shows frequency ranges within which NR may operate.

TABLE 4

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, physical channels that may be used in the 3GPP-based wireless communication system will be described in detail.

A PDCCH carries DCI. For example, the PDCCH (i.e., DCI) carries information about transport format and resource allocation of a downlink shared channel (DL-SCH), information about resource allocation of an uplink shared channel (UL-SCH), paging information about a paging channel (PCH), system information about the DL-SCH, information about resource allocation for a control message, such as a random access response (RAR) transmitted on a PDSCH, of a layer (hereinafter, higher layer) positioned higher than a physical layer among protocol stacks of the UE/BS, a transmit power control command, information about activation/deactivation of configured scheduling (CS), etc. DCI including information about resource allocation of the DL-SCH is referred to as PDSCH scheduling DCI, and DCI including information about resource allocation of the UL-SCH is referred to as PUSCH scheduling DCI. The DCI includes a cyclic redundancy check (CRC). The CRC is masked/scrambled with various identifiers (e.g., radio network temporary identifier (RNTI)) according to an owner or usage of the PDCCH. For example, if the PDCCH is for a specific UE, the CRS is masked with a UE identifier (e.g., cell-RNTI (C-RNTI)). If the PDCCH is for a paging message, the CRC is masked with a paging RNTI (P-RNTI). If the PDCCH is for system information (e.g., system information block (SIB)), the CRC is masked with a system information RNTI (SI-RNTI). If the PDCCH is for a random access response, the CRC is masked with a random access-RNTI (RA-RNTI).

When a PDCCH on one serving cell schedules a PDSCH or a PUSCH on another serving cell, it is referred to cross-carrier scheduling. Cross-carrier scheduling with a carrier indicator field (CIF) may allow a PDCCH on a serving cell to schedule resources on another serving cell. When a PDSCH on a serving cell schedules a PDSCH or a PUSCH on the serving cell, it is referred to as self-carrier scheduling. When the cross-carrier scheduling is used in a cell, the BS may provide information about a cell scheduling the cell to the UE. For example, the BS may inform the UE whether a serving cell is scheduled by a PDCCH on another (scheduling) cell or scheduled by the serving cell. If the serving cell is scheduled by the other (scheduling) cell, the BS may inform the UE which cell signals DL assignments and UL grants for the serving cell. In the present disclosure, a cell carrying a PDCCH is referred to as a scheduling cell, and a cell where transmission of a PUSCH or a PDSCH is scheduled by DCI included in the PDCCH, that is, a cell carrying the PUSCH or PDSCH scheduled by the PDCCH is referred to as a scheduled cell.

A PDSCH is a physical layer UL channel for UL data transport. The PDSCH carries DL data (e.g., DL-SCH transport block) and is subjected to modulation such as quadrature phase shift keying (QPSK), 16 quadrature amplitude modulation (QAM), 64 QAM, 256 QAM, etc. A codeword is generated by encoding a transport block (TB). The PDSCH may carry a maximum of two codewords. Scrambling and modulation mapping per codeword may be performed and modulation symbols generated from each codeword may be mapped to one or more layers. Each layer is mapped to a radio resource together with a DMRS and generated as an OFDM symbol signal. Then, the OFDM symbol signal is transmitted through a corresponding antenna port.

A PUCCH means a physical layer UL channel for UCI transmission. The PUCCH carries UCI. UCI types transmitted on the PUCCH may include hybrid automatic repeat request acknowledgement (HARQ-ACK) information, a scheduling request (SR), and channel state information (CSI). UCI bits may include HARQ-ACK information bits if any, SR information bits if any, link recovery request (LRR) information bits if any, and CSI bits if any. In the present disclosure, the HARQ-ACK information bits may correspond to a HARQ-ACK codebook. In particular, a bit sequence in which HARQ-ACK information bits are arranged according to a predetermined rule is called the HARQ-ACK codebook.
Scheduling request (SR): Information that is used to request a UL-SCH resource.
Hybrid automatic repeat request (HARQ)—acknowledgment (ACK): A response to a DL data packet (e.g., codeword) on the PDSCH. HARQ-ACK indicates whether the DL data packet has been successfully received by a communication device. In response to a single codeword, 1-bit HARQ-ACK may be transmitted. In response to two codewords, 2-bit HARQ-ACK may be transmitted. The HARQ-ACK response includes positive ACK (simply, ACK), negative ACK (NACK), discontinuous transmission (DTX), or NACK/DTX. Here, the term HARQ-ACK is used interchangeably with HARQ ACK/NACK, ACK/NACK, or A/N.
Channel state information (CSI): Feedback information about a DL channel. The CSI may include channel quality information (CQI), a rank indicator (RI), a precoding matrix indicator (PMI), a CSI-RS resource indicator (CRI), an SS/PBCH resource block indicator (SSBRI), and a layer indicator (L1). The CSI may be classified into CSI part 1 and CSI part 2 according to UCI type included in the CSI. For example, the CRI, RI, and/or the CQI for the first codeword may be included in CSI part 1, and LI, PMI, and/or the CQI for the second codeword may be included in CSI part 2.
Link recovery request (LRR):

In the present disclosure, for convenience, PUCCH resources configured/indicated for/to the UE by the BS for HARQ-ACK, SR, and CSI transmission are referred to as a HARQ-ACK PUCCH resource, an SR PUCCH resource, and a CSI PUCCH resource, respectively.

PUCCH formats may be defined as follows according to UCI payload sizes and/or transmission lengths (e.g., the number of symbols included in PUCCH resources). In regard to the PUCCH formats, reference may also be made to Table 5.

(0) PUCCH Format 0 (PF0 or F0)
Supported UCI payload size: up to K bits (e.g., K=2)
Number of OFDM symbols constituting a single PUCCH: 1 to X symbols (e.g., X=2)
Transmission structure: Only a UCI signal without a DMRS is included in PUCCH format 0. The UE transmits a UCI state by selecting and transmitting one of a plurality of sequences. For example, the UE transmits specific UCI to the BS by transmitting one of a plurality of sequences through a PUCCH, which is PUCCH format 0. The UE transmits the PUCCH, which is PUCCH format 0, in PUCCH resources for a corresponding SR configuration only upon transmitting a positive SR.
Configuration for PUCCH format 0 includes the following parameters for a corresponding PUCCH resource: an index for initial cyclic shift, the number of symbols for PUCCH transmission, and/or the first symbol for PUCCH transmission.

(1) PUCCH Format 1 (PF1 or F1)
Supported UCI payload size: up to K bits (e.g., K=2)
Number of OFDM symbols constituting a single PUCCH: Y to Z symbols (e.g., Y=4 and Z=14)
Transmission structure: The DMRS and UCI are configured/mapped in TDM in/to different OFDM symbols. In other words, the DMRS is transmitted in symbols in which modulation symbols are not transmitted and the UCI is represented as the product between a specific sequence (e.g., orthogonal cover code (OCC)) and a modulation (e.g., QPSK) symbol. Code division multiplexing (CDM) is supported between a plurality of PUCCH resources (conforming to PUCCH format 1) (within the same RB) by applying cyclic shifts (CSs)/OCCs to both the UCI and the DMRS. PUCCH format 1 carries the UCI of up to 2 bits and the modulation symbols are spread by the OCC (differently configured depending on whether frequency hopping is performed) in the time domain.
Configuration for PUCCH format 1 includes the following parameters for a corresponding PUCCH resource: an index for initial cyclic shift, the number of symbols for PUCCH transmission, the first symbol for PUCCH transmission, and/or an index for the OCC.

(2) PUCCH Format 2 (PF2 or F2)
Supported UCI payload size: more than K bits (e.g., K=2)
Number of OFDM symbols constituting a single PUCCH: 1 to X symbols (e.g., X=2)
Transmission structure: The DMRS and UCI are configured/mapped using frequency division multiplexing (FDM) within the same symbol. The UE transmits the UCI by applying only IFFT without DFT to encoded UCI bits. PUCCH format 2 carries UCI of a larger bit size than K bits and modulation symbols are subjected to FDM with the DMRS, for transmission. For example, the DMRS is located in symbol indexes #1, #4 , #7, and #10 within a given RB with the density of 1/3. A pseudo noise (PN) sequence is used for a DMRS sequence. Frequency hopping may be activated for 2-symbol PUCCH format 2.
Configuration for PUCCH format 2 includes the following parameters for a corresponding PUCCH resource: the number of PRBs, the number of symbols for PUCCH transmission, and/or the first symbol for PUCCH transmission.

(3) PUCCH Format 3 (PF3 or F3)
Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. The UE transmits the UCI by applying DFT to encoded UCI bits. PUCCH format 3 does not support UE multiplexing for the same time-frequency resource (e.g., same PRB).

Configuration for PUCCH format 3 includes the following parameters for a corresponding PUCCH resource: the number of PRBs, the number of symbols for PUCCH transmission, and/or the first symbol for PUCCH transmission.

(4) PUCCH Format 4 (PF4 or F4)
Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. PUCCH format 4 may multiplex up to 4 UEs in the same PRB, by applying an OCC at the front end of DFT and applying a CS (or interleaved FDM (IFDM) mapping) to the DMRS. In other words, modulation symbols of the UCI are subjected to TDM with the DMRS, for transmission.
Configuration for PUCCH format 4 includes the following parameters for a corresponding PUCCH resource: the number of symbols for PUCCH transmission, length for the OCC, an index for the OCC, and the first symbol for PUCCH transmission.

The table below shows the PUCCH formats. The PUCCH formats may be divided into short PUCCH formats (formats 0 and 2) and long PUCCH formats (formats 1, 3, and 4) according to PUCCH transmission length.

TABLE 5

| | Length in | | | |
|---|---|---|---|---|
| | OFDM | | | |
| PUCCH | symbols | Number | | |
| format | N^{PUCCH}_{symb} | of bits | Usage | Etc. |
| 0 | 1-2 | =<2 | HARQ, SR | Sequence selection |
| 1 | 4-14 | =<2 | HARQ, [SR] | Sequence modulation |
| 2 | 1-2 | >2 | HARQ, CSI, | CP-OFDM |
| | | | [SR] | |
| 3 | 4-14 | >2 | HARQ, CSI, | DFT-s-OFDM(no UE |
| | | | [SR] | multiplexing) |
| 4 | 4-14 | >2 | HARQ, CSI, | DFT-s-OFDM(Pre |
| | | | [SR] | DFT OCC) |

A PUCCH resource may be determined according to a UCI type (e.g., A/N, SR, or CSI). A PUCCH resource used for UCI transmission may be determined based on a UCI (payload) size. For example, the BS may configure a plurality of PUCCH resource sets for the UE, and the UE may select a specific PUCCH resource set corresponding to a specific range according to the range of the UCI (payload) size (e.g., numbers of UCI bits). For example, the UE may select one of the following PUCCH resource sets according to the number of UCI bits, N_{UCI}.
PUCCH resource set #0, if the number of UCI bits=<2
PUCCH resource set #1, if 2<the number of UCI bits=<N₁
. . . .
PUCCH resource set #(K−1), if N_{K-2}<the number of UCI bits=<N_{K-1}

Here, K represents the number of PUCCH resource sets (K>1) and Nᵢ represents a maximum number of UCI bits supported by PUCCH resource set #i. For example, PUCCH resource set #1 may include resources of PUCCH formats 0 to 1, and the other PUCCH resource sets may include resources of PUCCH formats 2 to 4 (see Table 5).

Configuration for each PUCCH resource includes a PUCCH resource index, a start PRB index, and configuration for one of PUCCH format 0 to PUCCH format 4. The UE is configured with a code rate for multiplexing HARQ-ACK, SR, and CSI report(s) within PUCCH transmission using PUCCH format 2, PUCCH format 3, or PUCCH format 4, by the BS through a higher layer parameter maxCodeRate. The higher layer parameter maxCodeRate is used to determine how to feed back the UCI on PUCCH resources for PUCCH format 2, 3, or 4.

If the UCI type is SR and CSI, a PUCCH resource to be used for UCI transmission in a PUCCH resource set may be configured for the UE through higher layer signaling (e.g., RRC signaling). If the UCI type is HARQ-ACK for a semi-persistent scheduling (SPS) PDSCH, the PUCCH resource to be used for UCI transmission in the PUCCH resource set may be configured for the UE through higher layer signaling (e.g., RRC signaling). On the other hand, if the UCI type is HARQ-ACK for a PDSCH scheduled by DCI, the PUCCH resource to be used for UCI transmission in the PUCCH resource set may be scheduled by the DCI.

In the case of DCI-based PUCCH resource scheduling, the BS may transmit the DCI to the UE on a PDCCH and indicate a PUCCH resource to be used for UCI transmission in a specific PUCCH resource set by an ACK/NACK resource indicator (ARI) in the DCI. The ARI may be used to indicate a PUCCH resource for ACK/NACK transmission and also be referred to as a PUCCH resource indicator (PRI). Here, the DCI may be used for PDSCH scheduling and the UCI may include HARQ-ACK for a PDSCH. The BS may configure a PUCCH resource set including a larger number of PUCCH resources than states representable by the ARI by (UE-specific) higher layer (e.g., RRC) signaling for the UE. The ARI may indicate a PUCCH resource subset of the PUCCH resource set and which PUCCH resource in the indicated PUCCH resource subset is to be used may be determined according to an implicit rule based on transmission resource information about the PDCCH (e.g., the starting CCE index of the PDCCH).

For UL-SCH data transmission, the UE should include UL resources available for the UE and, for DL-SCH data reception, the UE should include DL resources available for the UE. The UL resources and the DL resources are assigned to the UE by the BS through resource allocation. Resource allocation may include time domain resource allocation (TDRA) and frequency domain resource allocation (FDRA). In the present disclosure, UL resource allocation is also referred to as a UL grant and DL resource allocation is referred to as DL assignment. The UL grant is dynamically received by the UE on the PDCCH or in RAR or semi-persistently configured for the UE by the BS through RRC signaling. DL assignment is dynamically received by the UE on the PDCCH or semi-persistently configured for the UE by the BS through RRC signaling.

On UL, the BS may dynamically allocate UL resources to the UE through PDCCH(s) addressed to a cell radio network temporary Identifier (C-RNTI). The UE monitors the PDCCH(s) in order to discover possible UL grant(s) for UL transmission. The BS may allocate the UL resources using a configured grant to the UE. Two types of configured grants, Type 1 and Type 2, may be used. In Type 1, the BS directly provides the configured UL grant (including periodicity) through RRC signaling. In Type 2, the BS may configure a periodicity of an RRC-configured UL grant through RRC signaling and signal, activate, or deactivate the configured UL grant through the PDCCH addressed to a configured scheduling RNTI (CS-RNTI). For example, in Type 2, the PDCCH addressed to the CS-RNTI indicates that the corresponding UL grant may be implicitly reused according to the configured periodicity through RRC signaling until deactivation.

On DL, the BS may dynamically allocate DL resources to the UE through PDCCH(s) addressed to the C-RNTI. The UE monitors the PDCCH(s) in order to discover possible DL grant(s). The BS may allocate the DL resources to the UE using SPS. The BS may configure a periodicity of configured DL assignment through RRC signaling and signal, activate, or deactivate the configured DL assignment through the PDCCH addressed to the CS-RNTI. For example, the PDCCH addressed to the CS-RNTI indicates that the corresponding DL assignment may be implicitly reused according to the configured periodicity through RRC signaling until deactivation.

Hereinafter, resource allocation by the PDCCH and resource allocation by RRC will be described in more detail.

Resource Allocation by PDCCH: Dynamic Grant/Assignment

The PDCCH may be used to schedule DL transmission on the PDSCH and UL transmission on the PUSCH. DCI on the PDCCH for scheduling DL transmission may include DL resource assignment that at least includes a modulation and coding format (e.g., modulation and coding scheme (MCS)) index I_{MCS}), resource allocation, and HARQ information, associated with a DL-SCH. DCI on the PDCCH for scheduling UL transmission may include a UL scheduling grant that at least includes a modulation and coding format, resource allocation, and HARQ information, associated with a UL-SCH. HARQ information on a DL-SCH or UL-SCH may include a new information indicator (NDI), transport block size (TBS), redundancy version (RV), and HARQ process ID (i.e., HARQ process number). The size and usage of the DCI carried by one PDCCH differs according to a DCI format. For example, DCI format 0_0, DCI format 0_1, or DCI format 0_2 may be used to schedule the PUSCH, and DCI format 1_0, DCI format 1_1, or DCI format 1_2 may be used to schedule the PDSCH. Particularly, DCI format 0_2 and DCI format 1_2 may be used to schedule transmission having higher transmission reliability and lower latency requirements than transmission reliability and latency requirement guaranteed by DCI format 0_0, DCI format 0_1, DCI format 1_0, or DCI format 1_1. Some implementations of the present disclosure may be applied to UL data transmission based on DCL format 0_2. Some implementations of the present disclosure may be applied to DL data reception based on DCI format 1_2.

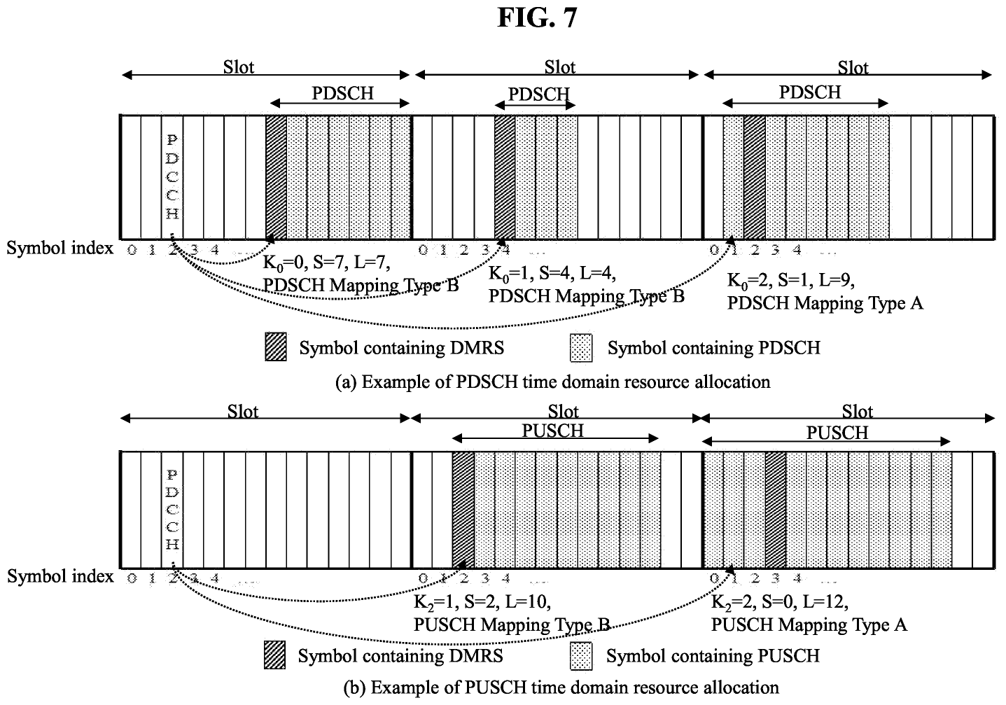

FIG. 7 illustrates an example of PDSCH TDRA caused by a PDCCH and an example of PUSCH TDRA caused by the PDCCH.

DCI carried by the PDCCH in order to schedule a PDSCH or a PUSCH includes a TDRA field. The TDRA field provides a value m for a row index m+1 to an allocation table for the PDSCH or the PUSCH. Predefined default PDSCH time domain allocation is applied as the allocation table for the PDSCH or a PDSCH TDRA table that the BS configures through RRC signaled pdsch-TimeDomainAllocationList is applied as the allocation table for the PDSCH. Predefined default PUSCH time domain allocation is applied as the allocation table for the PUSCH or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214).

In PDSCH time domain resource configurations, each indexed row defines a DL assignment-to-PDSCH slot offset K₀, a start and length indicator value SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. The PDSCH/PUSCH mapping type has two mapping types: mapping type A and mapping type B. In PDSCH/PUSCH mapping type A, a demodulation reference signal (DMRS) is mapped to a PDSCH/PUSCH resource based on the start of a slot. According to other DMRS parameters, one or two symbols among the symbols of the PDSCH/PUSCH resource may be used as DMRS symbol(s). For example, in PDSCH/PUSCH mapping type A, the DMRS is located on the third symbol (symbol #2) or the fourth symbol (symbol #3) in the slot according to RRC signaling. In PDSCH/PUSCH mapping type B, the DMRS is mapped based on the first OFDM symbol of the PDSCH/PUSCH resource. According to other DMRS parameters, one or two symbols from the first symbol of the PDSCH/PUSCH resource may be used as DMRS symbol(s). For example, in PDSCH/PUSCH mapping type B, the DMRS is located on the first symbol allocated for PDSCH/PUSCH. In the present disclosure, the PDSCH/PUSCH mapping type may be referred to as a mapping type or a DMRS mapping type. For example, in the present disclosure, PUSCH mapping type A may be referred to as mapping type A or DMRS mapping type A, and PUSCH mapping type B may be referred to as mapping type B or DMRS mapping type B.

The scheduling DCI includes an FDRA field that provides assignment information about RBs used for the PDSCH or the PUSCH. For example, the FDRA field provides information about a cell for PDSCH or PUSCH transmission to the UE, information about a BWP for PDSCH or PUSCH transmission, and/or information about RBs for PDSCH or PUSCH transmission.

Resource Allocation by RRC

As mentioned above, there are two types of transmission without dynamic grant: configured grant Type 1 and configured grant Type 2. In configured grant Type 1, a UL grant is provided by RRC and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC per serving cell and per BWP. Multiple configurations may be active simultaneously on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeDomainOffset indicating an offset of a resource with respect to system frame number (SFN)=0 in the time domain;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides I_{MCS} indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*numberOfSlotsPerFrame (numberOfSymbolsPerSlot)+(slot number in the frame*numberOfSymbolsPerSlot)+symbol number in the slot]=(timeDomainOffset*numberOfSymbolsPerSlot+S+N*periodicity) modulo (1024*numberOfSlotsPerFrame*numberOfSymbolsPerSlot), for all N>=0, where numberOfSlotsPerFrame and numberOfSymbolsPerSlot indicate the number of consecutive slots per frame and the number of consecutive OFDM symbols per slot, respectively (refer to Table 1 and Table 2).

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbol_{start time})+N*periodicity] modulo (1024*numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

In some scenarios, a parameter harq-ProcID-Offset and/or a parameter harq-ProcID-Offset2 used to derive HARQ process IDs for configured UL grants may be further provided by the BS to the UE. harq-ProcID-Offset is an offset of a HARQ process for a configured grant for operation with shared spectrum channel access, and harq-ProcID-Offset2 is an offset of a HARQ process for a configured grant. In the present disclosure, cg-RetransmissionTimer is a duration after (re)transmission based on a configured grant in which the UE should not autonomously perform retransmission based on the HARQ process of the (re)transmission. cg-Retransmission Timer may be provided to the UE by the BS when retransmission on a configured UL grant is configured. For configured grants configured with neither harq-ProcID-Offset nor cg-Retransmission Timer, the HARQ process ID associated with the first symbol of UL transmission may be derived from the following equation: HARQ Process ID=[floor(CURRENT_symbol/periodicity)] modulo nrofHARQ-Processes. For configured UL grants with harq-ProcID-Offset2, the HARQ process ID associated with the first symbol of UL transmission may be derived from the following equation: HARQ Process ID=[floor(CURRENT_symbol/periodicity)] modulo nrofHARQ-Processes+harq-ProcID-Offset2, where CURRENT_symbol=(SFN*numberOfSlotsPerFrame*numberOfSymbolsPerSlot+slot number in the frame*numberOfSymbolsPerSlot+symbol number in the slot), and numberOfSlotsPerFrame and numberOfSymbolsPerSlot denote the number of consecutive slots per frame and the number of consecutive OFDM symbols per slot, respectively. For configured UL grants with cg-Retransmission Timer, the UE may select a HARQ process ID from among HARQ process IDs available for the configured grant configuration.

On DL, the UE may be configured with semi-persistent scheduling (SPS) per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling used to configure a semi-persistent transmission:
cs-RNTI corresponding to a CS-RNTI for activation, deactivation, and retransmission;
nrofHARQ-Processes that provides the number of HARQ processes for SPS;
periodicity that provides a periodicity of configured DL assignment for SPS;
n1PUCCH-AN that provides a HARQ resource for a PUCCH for SPS (the network configures the HARQ resource as format 0 or format 1, and the actual PUCCH resource is configured by PUCCH-Config and referred to in n1PUCCH-AN by the ID thereof).

After DL assignment is configured for SPS, the UE may consider sequentially that N-th DL assignment occurs in a slot satisfying: (numberOfSlotsPerFrame*SFN+slot number in the frame)=[(numberOfSlotsPerFrame*SFN_{start time}+slot_{start time})+N*periodicity*numberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

In some scenarios, a parameter harq-ProcID-Offset used to derive HARQ process IDs for configured DL assignments may be further provided by the BS to the UE. harq-ProcID-Offset is an offset of a HARQ process for SPS. For configured DL assignments without harq-ProcID-Offset, a HARQ process ID associated with a slot in which DL transmission starts may be determined from the following equation: HARQ Process ID=[floor (CURRENT_slot*10/(numberOfSlotsPerFrame*periodicity))] modulo nrofHARQ-Processes, where CURRENT_slot=[(SFN*numberOfSlotsPerFrame)+slot number in the frame], and numberOfSlotsPerFrame denotes the number of consecutive slots per frame. For configured DL assignments with harq-ProcID-Offset, a HARQ process ID associated with a slot in which DL transmission starts may be determined from the following equation: HARQ Process ID=[floor (CURRENT_slot/periodicity)] modulo nrofHARQ-Processes+harq-ProcID-Offset, where CURRENT_slot=[(SFN*numberOfSlotsPerFrame)+slot number in the frame], and numberOfSlotsPerFrame denotes the number of consecutive slots per frame.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set according to Table 6 and Table 7. Table 6 shows an example of special fields for DL SPS and UL grant Type 2 scheduling activation PDCCH validation, and Table 7 shows an example of special fields for DL SPS and UL grant Type 2 scheduling release PDCCH validation.

TABLE 6

| | DCI format | DCI format | DCI format |
|---|---|---|---|
| | 0_0/0_1 | 1_0 | 1_1 |
| HARQ process | set to all ‘0’s | set to all ‘0’s | set to all ‘0’s |
| number | | | |
| Redundancy | set to ‘00’ | set to ‘00’ | For the enabled transport |
| version | | | block: set to ‘00’ |

TABLE 7

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding | set to all ‘1’s | set to all ‘1’s |
| scheme | | |
| Resource block | set to all ‘1’s | set to all ‘1’s |
| assignment | | |

Actual DL assignment and UL grant for DL SPS or UL grant Type 2, and a corresponding MCS are provided by resource assignment fields (e.g., a TDRA field providing a TDRA value m, an FDRA field providing frequency resource block assignment, and/or an MCS field) in the DCI format carried by a corresponding DL SPS or UL grant Type 2 scheduling activation PDCCH. If validation is achieved, the UE considers information in the DCI format as valid activation or valid release of DL SPS or configured UL grant Type 2.

In the present disclosure, a PDSCH based on DL SPS may be referred to as an SPS PDSCH, and a PUSCH based on a UL configured grant (CG) may be referred to as a CG PUSCH. A PDSCH dynamically scheduled by DCI carried on a PDCCH may be referred to as a dynamic grant (DG) PDSCH, and a PUSCH dynamically scheduled by DCI carried by on a PDCCH may be referred to as a DG PUSCH.

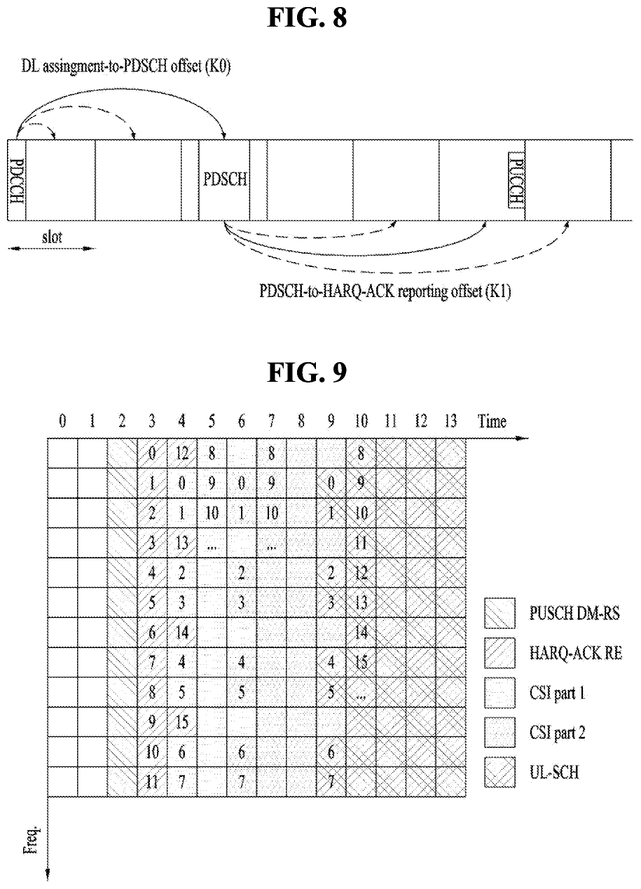

FIG. 8 illustrates a HARQ-ACK transmission/reception procedure.

Referring to FIG. 8, the UE may detect a PDCCH in a slot n. Next, the UE may receive a PDSCH in a slot n+K0 according to scheduling information received through the PDCCH in the slot n and then transmit UCI through a PUCCH in a slot n+K1. In this case, the UCI includes a HARQ-ACK response for the PDSCH.

The DCI (e.g., DCI format 1_0 or DCI format 1_1) carried by the PDCCH for scheduling the PDSCH may include the following information.
FDRA: FDRA indicates an RB set allocated to the PDSCH.
TDRA: TDRA indicates a DL assignment-to-PDSCH slot offset K0, the start position (e.g., symbol index S) and length (e.g., the number of symbols, L) of the PDSCH in a slot, and the PDSCH mapping type. PDSCH mapping Type A or PDSCH mapping Type B may be indicated by TDRA. For PDSCH mapping Type A, the DMRS is located in the third symbol (symbol #2) or fourth symbol (symbol #3) in a slot. For PDSCH mapping Type B, the DMRS is allocated in the first symbol allocated for the PDSCH.
PDSCH-to-HARQ_feedback timing indicator: This indicator indicates K1.

If the PDSCH is configured to transmit a maximum of one TB, a HARQ-ACK response may consist of one bit. If the PDSCH is configured to transmit a maximum of 2 TBs, the HARQ-ACK response may consist of 2 bits when spatial bundling is not configured and one bit when spatial bundling is configured. When a HARQ-ACK transmission timing for a plurality of PDSCHs is designated as slot n+K1, UCI transmitted in slot n+K1 includes a HARQ-ACK response for the plural PDSCHs.

In the present disclosure, a HARQ-ACK payload consisting of HARQ-ACK bit(s) for one or plural PDSCHs may be referred to as a HARQ-ACK codebook. The HARQ-ACK codebook may be categorized as a semi-static HARQ-ACK codebook and a dynamic HARQ-ACK codebook according to a HARQ-ACK payload determination scheme.

In the case of the semi-static HARQ-ACK codebook, parameters related to a HARQ-ACK payload size that the UE is to report are semi-statically determined by a (UE-specific) higher layer (e.g., RRC) signal. The HARQ-ACK payload size of the semi-static HARQ-ACK codebook, e.g., the (maximum) HARQ-ACK payload (size) transmitted through one PUCCH in one slot, may be determined based on the number of HARQ-ACK bits corresponding to a combination (hereinafter, bundling window) of all DL carriers (i.e., DL serving cells) configured for the UE and all DL scheduling slots (or PDSCH transmission slots or PDCCH monitoring slots) for which the HARQ-ACK transmission timing may be indicated. That is, in a semi-static HARQ-ACK codebook scheme, the size of the HARQ-ACK codebook is fixed (to a maximum value) regardless of the number of actually scheduled DL data. For example, DL grant DCI (PDCCH) includes PDSCH-to-HARQ-ACK timing information, and the PDSCH-to-HARQ-ACK timing information may have one (e.g., k) of a plurality of values. For example, when the PDSCH is received in slot #m and the PDSCH-to-HARQ-ACK timing information in the DL grant DCI (PDCCH) for scheduling the PDSCH indicates k, the HARQ-ACK information for the PDSCH may be transmitted in slot #(m+k). As an example, k∈{1, 2, 3, 4, 5, 6, 7, 8}. When the HARQ-ACK information is transmitted in slot #n, the HARQ-ACK information may include possible maximum HARQ-ACK based on the bundling window. That is, HARQ-ACK information of slot #n may include HARQ-ACK corresponding to slot #(n−k). For example, when k∈{1, 2, 3, 4, 5, 6, 7, 8}, the HARQ-ACK information of slot #n may include HARQ-ACK corresponding to slot #(n−8) to slot #(n−1) regardless of actual DL data reception (i.e., HARQ-ACK of a maximum number). Here, the HARQ-ACK information may be replaced with a HARQ-ACK codebook or a HARQ-ACK payload. A slot may be understood/replaced as/with a candidate occasion for DL data reception. As described in the example, the bundling window may be determined based on the PDSCH-to-HARQ-ACK timing based on a HARQ-ACK slot, and a PDSCH-to-HARQ-ACK timing set may have predefined values (e.g., {1, 2, 3, 4, 5, 6, 7, 8}) or may be configured by higher layer (RRC) signaling. In the case of the dynamic HARQ-ACK codebook, the HARQ-ACK payload size that the UE is to report may be dynamically changed by the DCI etc. In the dynamic HARQ-ACK codebook scheme, DL scheduling DCI may include a counter-DAI (i.e., c-DAI) and/or a total-DAI (i.e., t-DAI). Here, the DAI indicates a downlink assignment index and is used for the BS to inform the UE of transmitted or scheduled PDSCH(s) for which HARQ-ACK(s) are to be included in one HARQ-ACK transmission. Particularly, the c-DAI is an index indicating order between PDCCHs carrying DL scheduling DCI (hereinafter, DL scheduling PDCCHs), and t-DAI is an index indicating the total number of DL scheduling PDCCHs up to a current slot in which a PDCCH with the t-DAI is present.

A semi-static HARQ-ACK codebook may be referred to as a Type-1 HARQ-ACK codebook, and a dynamic HARQ-ACK codebook may be referred to as a Type-2 HARQ-ACK codebook.

In the NR system, a method of implementing a plurality of logical networks in a single physical network is considered. The logical networks need to support services with various requirements (e.g., eMBB, mMTC, URLLC, etc.). Accordingly, a physical layer of NR is designed to support a flexible transmission structure in consideration of the various service requirements. As an example, the physical layer of NR may change, if necessary, an OFDM symbol length (OFDM symbol duration) and a subcarrier spacing (SCS) (hereinafter, OFDM numerology). Transmission resources of physical channels may also be changed in a predetermined range (in units of symbols). For example, in NR, a PUCCH (resource) and a PUSCH (resource) may be configured to flexibly have a transmission length/transmission start timing within a predetermined range.

A PDCCH is transmitted through a control resource set (CORESET). One or more CORESETs may be configured for the UE. The CORESET consists of a set of PRBs with a duration of 1 to 3 OFDM symbols. The PRBs and a CORESET duration that constitute the CORESET may be provided to the UE through higher layer (e.g., RRC) signaling. A set of PDCCH candidates in the configured CORESET(s) is monitored according to corresponding search space sets. In the present disclosure, monitoring implies decoding (called blind decoding) each PDCCH candidate according to monitored DCI formats. A master information block (MIB) on a PBCH provides parameters (e.g., CORESET #0 configuration) for monitoring a PDCCH for scheduling a PDSCH carrying system information block 1 (SIB1) to the UE. The PBCH may also indicate that there is no associated SIB1. In this case, the UE may be provided with not only a frequency range in which the UE may assume that there is no SSB associated with SSB1 but also other frequencies to search for an SSB associated with SIB1. CORESET #0, which is a CORESET for scheduling SIB1 at least, may be configured by the MIB or dedicated RRC signaling.

A set of PDCCH candidates monitored by the UE is defined in terms of PDCCH search space sets. The search space set may be a common search space (CS S) set or a UE-specific search space (USS) set. Each CORESET configuration is associated with one or more search space sets, and each search space set is associated with one CORESET configuration. The search space set is determined based on the following parameters provided by the BS to the UE.
controlResourceSetId: an identifier for identifying a CORESET p associated with a search space set s.
monitoringSlotPeriodicityAndOffset: a PDCCH monitoring periodicity of slots kₛ and a PDCCH monitoring offset of oₛ slots to configure slots for PDCCH monitoring.
duration: a duration of Tₛ<kₛ slots indicating a number of slots in which the search space set s exists.
monitoringSymbolsWithinSlot: a PDCCH monitoring pattern within a slot, indicating first symbol(s) of the CORESET within a slot for PDCCH monitoring.
nrofCandidates: a number of PDCCH candidates per CCE aggregation level.
searchSpaceType: an indication that search space set s is either a CCE set or a USS set.

The parameter monitoringSymbolsWithinSlot may indicate the first symbol(s) for PDCCH monitoring in the slots configured for PDCCH monitoring (e.g., see monitoringSlotPeriodicityAndOffset and duration). For example, when monitoringSymbolsWithinSlot is a 14-bit parameter, the most significant (leftmost) bit may represent the first OFDM symbol in the slot, and the second most significant (leftmost) bit may represent the second OFDM symbol in the slot. In this way, the bits of monitoringSymbolsWithinSlot may represent the 14 OFDM symbols of the slot, respectively. For example, bit(s) set to 1 among the bits in monitoringSymbolsWithinSlot may identify the first symbol(s) of the CORESET in the slot.

A UE monitors PDCCH candidates in PDCCH monitoring occasions only. The UE determines a monitoring occasion on an active DL BWP from the PDCCH monitoring periodicity, the PDCCH monitoring offset, and the PDCCH monitoring pattern within a slot. In some implementations, for search space set s, the UE determines that a PDCCH monitoring occasion(s) existing in a slot with number n^{u}_{s,f} in a frame with number n_{f} if (n_{f}*N^{frame,u}ₛₗₒₜ+n^{u}_{s,f}−oₛ) mod kₛ=0. The UE monitors PDCCH candidates for search space set s for Tₛ consecutive slots, starting from slot n^{u}_{s,f}, and does not monitor PDCCH candidates for search space set s for the next kₛ−Tₛ.

The following table shows search space sets, related RNTIs, and use cases thereof.

TABLE 8

| | Search | | |
|---|---|---|---|
| Type | Space | RNTI | Use Case |
| Type0-PDCCH | Common | SI-RNTI on a primary cell | SIB Decoding |
| Type0A-PDCCH | Common | SI-RNTI on a primary cell | SIB Decoding |
| Type1-PDCCH | Common | RA-RNTI or TC-RNTI on a | Msg2, Msg4 |
| | | primary cell | decoding in |
| | | | RACH |
| Type2-PDCCH | Common | P-RNTI on a primary cell | Paging Decoding |
| Type3-PDCCH | Common | INT-RNTI, SFI-RNTI, TPC- | |
| | | PUSCH-RNTI, TPC-PUCCH- | |
| | | RNTI, TPC-SRS-RNTI, C- | |
| | | RNTI, MCS-C-RNTI, or CS- | |
| | | RNTI(s) | |
| | UE Specific | C-RNTI, or MCS-C-RNTI, or | User specific |
| | | CS-RNTI(s) | PDSCH decoding |

The following table shows DCI formats carried by a PDCCH.

TABLE 9

| DCI_format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |
| 2_4 | Notifying a group of UEs of PRB(s) and OFDM symbol(s) |
| | where UE cancels the corresponding UL transmission |
| | from the UE |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH. For a CSS, DCI format 0_0 and DCI format 1_0 have fixed sizes after the BWP size is initially given by RRC. For a USS, DCI format 0_0 and DCI format 1_0 are fixed in size in fields other than a frequency domain resource assignment (FDRA) field, and the FDRA field may vary in size by configuration of a related parameter by the BS. In DCI format 0_1 and DCI format 1_1, the size of the DCI field may be changed by various RRC reconfigurations by the BS. DCI format 2_0 may be used to provide dynamic slot format information (e.g., SFI DCI) to the UE, DCI format 2_1 may be used to provide DL pre-emption information to the UE, and DCI format 2_4 may be used to indicate a UL resource on which the UE needs to cancel UL transmission.

In a wireless communication system including the BS and the UE, when the UE transmits UCI on a PUCCH, a PUCCH resource may overlap with another PUCCH resource or a PUSCH resource on the time axis. For example, (1) a PUCCH (resource) and a PUCCH (resource) (for different UCI transmission) or (2) a PUCCH (resource) and a PUSCH (resource) may overlap on the time axis (in the same slot) in terms of the same UE. The UE may not support PUCCH-PUCCH simultaneous transmission or PUCCH-PUSCH simultaneous transmission (according to restrictions on UE capability or according to configuration information received from the BS). In addition, the UE may not be allowed to simultaneously transmit a plurality UL channels within a predetermined time range.

In the present disclosure, methods of handling a plurality of UL channels when the UL channels that the UE should transmit are present in a predetermined time range are described. In the present disclosure, methods of handling UCI and/or data that should have been transmitted/received on the UL channels are also described. The following terms are used in a description of examples in the present disclosure.
UCI: UCI implies control information that the UE transmits on UL. The UCI includes multiple types of control information (i.e., UCI types). For example, the UCI may include HARQ-ACK (shortly, A/N or AN), SR, and/or CSI.
UCI multiplexing: UCI multiplexing may mean an operation of transmitting different UCIs (UCI types) on a common physical UL channel (e.g., a PUCCH or PUSCH). UCI multiplexing may include multiplexing of different UCIs (UCI types). For convenience, the multiplexed UCI is referred to as MUX UCI. Further, UCI multiplexing may include an operation performed in relation to MUX UCI. For example, UCI multiplexing may include a process of determining a UL channel resource to transmit MUX UCI.
UCI/data multiplexing: UCI/data multiplexing may mean an operation of transmitting UCI and data on a common physical UL channel (e.g., PUSCH). UCI/data multiplexing may include an operation of multiplexing UCI with data. For convenience, the multiplexed UCI is referred to as MUX UCI/data. Further, UCI/data multiplexing may include an operation performed in relation to MUX UCI/data. For example, UCI/data multiplexing may include a process of determining a UL channel resource to transmit MUX UCI/data.
Slot: Slot means a basic time unit or time interval for data scheduling. A slot includes a plurality of symbols. Here, a symbol may be an OFDM-based symbol (e.g., a CP-OFDM symbol or DFT-s-OFDM symbol).
Overlapping UL channel resource(s): Overlapping UL channel resource(s) mean UL channel (e.g., PUCCH or PUSCH) resource(s) overlapping (at least partially) with each other on the time axis within a predetermined time period (e.g., slot). Overlapping UL channel resource(s) may imply UL channel resource(s) before UCI multiplexing is performed. In the present disclosure, (at least partially) overlapping UL channels on the time axis are referred to as colliding UL channels in time or in the time domain.

FIG. 9 illustrates an example of multiplexing UCI with a PUSCH. When PUCCH resource(s) and a PUSCH resource overlap in a slot and PUCCH-PUSCH simultaneous transmission is not configured, UCI may be transmitted on the PUSCH as illustrated. Transmission of the UCI on the PUSCH is referred to as UCI piggyback or PUSCH piggyback. Particularly, FIG. 9 illustrates the case in which HARQ-ACK and CSI are carried on the PUSCH resource.

When a plurality of UL channels overlaps within a predetermined time interval, a method for the UE to process the UL channels needs to be specified in order to allow the BS to correctly receive the UL channel(s). Hereinafter, methods of handling collision between UL channels will be described.

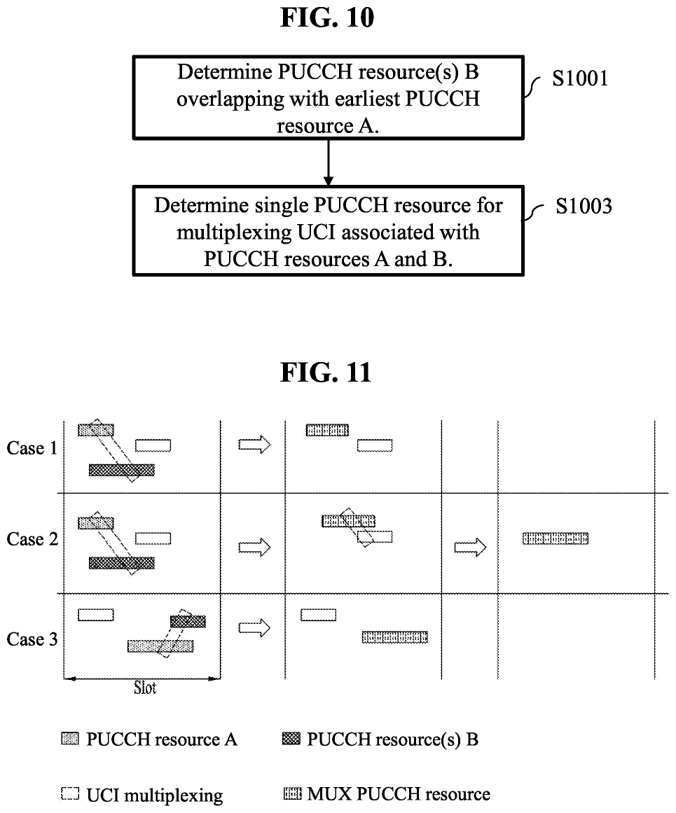

FIG. 10 illustrates an example of a process for a UE with overlapping PUCCHs in a single slot to handle collision between UL channels.

To transmit UCI, the UE may determine PUCCH resources for each UCI. Each PUCCH resource may be defined by a start symbol and a transmission interval. When PUCCH resources for PUCCH transmission overlap in a single slot, the UE may perform UCI multiplexing based on a PUCCH resource with the earliest start symbol. For example, the UE may determine overlapping PUCCH resource(s) (in time) (hereinafter, PUCCH resource(s) B) based on a PUCCH resource with the earliest start symbol (hereinafter, PUCCH resource A) in a slot (S1001). The UE may apply a UCI multiplexing rule to the PUCCH resource A and the PUCCH resource(s) B. For example, based on UCI A of the PUCCH resource A and UCI B of the PUCCH resource(s) B, MUX UCI including all or part of the UCI A and the UCI B may be obtained according to the UCI multiplexing rule. To multiplex UCI associated with the PUCCH resource A and the PUCCH resource(s) B, the UE may determine a single PUCCH resource (hereinafter, MUX PUCCH resource) (S1003). For example, the UE determines a PUCCH resource set corresponding to a payload size of the MUX UCI (hereinafter, PUCCH resource set X) among PUCCH resource sets configured or available for the UE and determines one of PUCCH resources belonging to the PUCCH resource set X as a MUX PUCCH resource. For example, the UE may determine one of the PUCCH resources belonging to the PUCCH resource set X as the MUX PUCCH resource, using a PUCCH resource indicator field in the last DCI among DCIs having a PDSCH-to-HARQ feedback timing indicator field that indicates the same slot for PUCCH transmission. The UE may determine the total number of PRBs of the MUX PUCCH resource based on the payload size of the MUX UCI and a maximum code rate for a PUCCH format of the MUX PUCCH resource. If the MUX PUCCH resource overlaps with other PUCCH resources (except for the PUCCH resource A and the PUCCH resource(s) B), the UE may perform the above-described operation again based on the MUX PUCCH resource (or a PUCCH resource having the earliest start symbol among the other PUCCH resources including the MUX PUCCH resource).

FIG. 11 illustrates cases for performing UCI multiplexing based on FIG. 10. Referring to FIG. 11, when a plurality of PUCCH resources overlap in a slot, UCI multiplexing may be performed based on the earliest PUCCH resource A (e.g., PUCCH resource A with the earliest start symbol). In FIG. 10, Case 1 and Case 2 show that the first PUCCH resource overlaps with another PUCCH resource. In this case, the process of FIG. 10 may be performed in a state in which the first PUCCH resource is regarded as the earliest PUCCH resource A. In contrast, Case 3 shows that the first PUCCH resource does not overlap with another PUCCH resource and the second PUCCH resource overlaps with another PUCCH resource. In Case 3, UCI multiplexing is not performed on the first PUCCH resource. Instead, the process of FIG. 10 may be performed in a state in which the second PUCCH resource is regarded as the earliest PUCCH resource A. Case 2 shows that a MUX PUCCH resource determined to transmit the multiplexed UCI newly overlaps with another PUCCH resource. In this case, the process of FIG. 10 may be additionally performed in a state in which the MUX PUCCH resource (or the earliest PUCCH resource (e.g., a PUCCH resource having the earliest start symbol) among the other PUCCH resources including the MUX PUCCH resource) is regarded as the earliest PUCCH resource A.

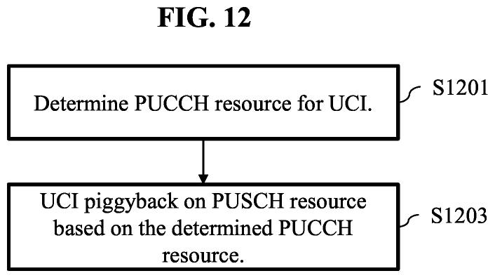

FIG. 12 illustrates a process for a UE with an overlapping PUCCH and PUSCH in a single slot to handle collision between UL channels.

To transmit UCI, the UE may determine a PUCCH resource (S1201). Determination of the PUCCH resource for the UCI may include determining a MUX PUCCH resource. In other words, determination of the PUCCH resource for the UCI by the UE may include determining the MUX PUCCH resource based on a plurality of overlapping PUCCHs in a slot.

The UE may perform UCI piggyback on a PUSCH resource based on the determined (MUX) PUCCH resource (S1203). For example, when there is a PUSCH resource (on which multiplexed UCI transmission is allowed), the UE may apply the UCI multiplexing rule to PUCCH resource(s) overlapping with the PUSCH resource (on the time axis). The UE may transmit the UCI on the PUSCH.

When there is no PUSCH overlapping with the determined PUCCH resource in a slot, S1103 is omitted and the UCI may be transmitted on the PUCCH.

When the determined PUCCH resource overlaps with a plurality of PUSCHs on the time axis, the UE may multiplex the UCI with one of the PUSCHs. For example, when the UE intends to transmit the PUSCHs to respective serving cells, the UE may multiplex the UCI on a PUSCH of a specific serving cell (e.g., a serving cell having the smallest serving cell index) among the serving cells. When more than one PUSCH is present in the slot of the specific serving cell, the UE may multiplex the UCI on the earliest PUSCH transmitted in the slot.

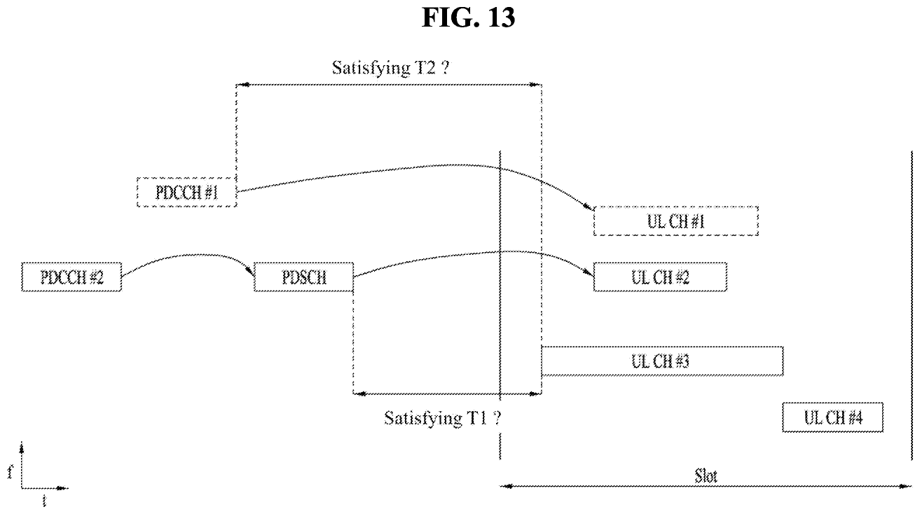

FIG. 13 illustrates UCI multiplexing considering a timeline condition. When the UE performs UCI and/or data multiplexing for overlapping PUCCH(s) and/or PUSCH(s) on the time axis, the UE may be lacking in processing time for UCI and/or data multiplexing due to flexible UL timing configuration for the PUCCH or the PUSCH. In order to prevent the processing time of the UE from being insufficient, two timeline conditions (hereinafter, multiplexing timeline conditions) described below are considered in a process of performing UCI/data multiplexing for the overlapping PUCCH(s) and/or PUSCH(s) (on the time axis).

(1) The last symbol of a PDSCH corresponding to HARQ-ACK information is received before time T1 from the start symbol of the earliest channel among the overlapping PUCCH(s) and/or PUSCH(s) (on the time axis). T1 may be determined based on i) a minimum PDSCH processing time N1 defined according to a UE processing capability, and/or ii) d_{1,1} predefined as an integer equal to or greater than 0 according to a position of scheduled symbol(s), PDSCH mapping type, BWP switching, etc.

For example, T1 may be determined as follows: T1=(N1+d_{1,1})*(2048+144)*κ*2^{-u}*T_{c}. N1 is based on u of Table 10 and Table 11 for UE processing capabilities #1 and #2, respectively, and u is one of (u_{PDCCH}, u_{PDSCH}, u_{UL}), that causes the largest T1, where u_{PDCCH} corresponds to a subcarrier spacing of a PDCCH for scheduling the PDSCH, u_{PDSCH} corresponds to a subcarrier spacing of the scheduled PDSCH, u_{UL} corresponds to a subcarrier spacing of a UL channel on which HARQ-ACK is to be transmitted, and κ=T_{c}/T_{f}=64. In Table 10, in the case of N_{1,0}, if a PDSCH DMRS position of an added DMRS is l₁=12, then N_{1,0}=14 and, otherwise, N_{1,0}=13 (refer to Section 7.4.1.1.2 of 3GPP TS 38.211). If the last symbol of the PDSCH for PDSCH mapping type A is present on an i-th slot, d_{1,1}=7−i for i<7 and, otherwise, d_{1,1}=0. If the PDSCH has mapping type B for UE processing capability #1, d_{1,1} may be 0 when the number of allocated PDSCH symbols is 7, d_{1,1} may be 3 when the number of allocated PDSCH symbols is 4, d_{1,1} may be 3+d when the number of allocated PDSCH symbols is 2, where d is the number of overlapping symbols of the scheduling PDCCH and the scheduled PDSCH. If the PDSCH mapping type is B for UE processing capability #2, d_{1,1} may be 0 when the number of allocated PDSCH symbols is 7, and d_{1,1} may correspond to the number of overlapping symbols of the scheduling PDCCH and the scheduled PDSCH when the number of allocated PDSCH symbols is 4. Further, if the number of allocated PDSCH symbols is 2, d_{1,1} may be 3 when the scheduling PDSCH is within a 3-symbol CORESET and the CORESET and the PDSCH have the same starting symbol, and d_{1,1} may be the number of overlapping symbols of the scheduling PDCCH and the scheduled PDSCH for the other cases. In the present disclosure T1 may also be referred to as T_proc,1.

(2) The last symbol of a (e.g., triggering) PDCCH for indicating PUCCH or PUSCH transmission is received before time T2 from the start symbol of the earliest channel among overlapping PUCCH(s) and/or PUSCH(s) (on the time axis). T2 may be determined based on i) a minimum PUSCH preparation time N1 defined according to a UE PUSCH timing capability, and/or ii) d_{2,x} predefined as an integer equal to or greater than 0 according to the scheduled symbol position, BWP switching, etc. d_{2,x} may be categorized into d_{2,1} related to the position of scheduled symbol(s) and d_{2,2} related to BWP switching.

For example, T2 may be determined as follows: T2=max{(N2+d_{2,1})*(2048+144)*κ*2^{-u}*T_{c}+Tₑₓₜ+T_{switch}, d_{2,2}}. N2 is based on u of Table 12 and Table 13 for UE timing capabilities #1 and #2, respectively, and u is one of (u_{DL}, u_{UL}), that causes the largest T1, where u_{DL} corresponds to a subcarrier spacing of a PDCCH carrying DCI for scheduling a PUSCH, u_{UL} corresponds to a subcarrier spacing of the PUSCH, and κ=T_{c}/T_{f}=64. For operation with shared spectrum channel access, Tₑₓₜ may be computed according to Section 5.3.1 of 3GPP TS 38.211. Otherwise, Tₑₓₜ=0. When a UL switching gap is triggered according to a predefined condition, T_{switch} is the same as the duration of the switching gap. Otherwise, T_{switch}=0 for the UE configured with a higher layer parameter uplinkTxSwitchingOption set to ‘dualUL’ for UL carrier aggregation of u_{UL}=min(u_{UL,carrier1}, u_{UL,carrier2}). If the first symbol of PUSCH allocation is composed only of a DMRS, then d_{2,1} may be 0 and, otherwise, d_{2,1} may be 1. If the scheduling DCI has triggered BWP switching, d_{2,2} is equal to a switching time and, otherwise, d_{2,2} is 0. The switching time may be differently defined depending on a frequency range (FR). For example, the switching time may be defined as 0.5 ms for FR1 and as 0.25 ms for FR2. In the present disclosure, T2 may also be referred to as T_proc,2.

Tables below show processing times according to UE processing capability. Particularly, Table 10 shows a PDSCH processing time for PDSCH processing capability #1 of the UE, Table 11 shows a PDSCH processing time for PDSCH processing capability #2 of the UE, Table 12 shows a PUSCH preparation time for PUSCH timing capability #1 of the UE, and Table 13 shows a PUSCH processing time for PUSCH timing capability #2 of the UE.

TABLE 10

PDSCH decoding time N₁ [symbols]

| | Front-loaded DMRS | Front-loaded + additional |
|---|---|---|
| u/SCS | only | DMRS |
| 0/15 kHz | 8 | N_{1, 0} |
| 1/30 kHz | 10 | 13 |
| 2/60 kHz | 17 | 20 |
| 3/120 kHz | 20 | 24 |

TABLE 11

| u/SCS | PDSCH decoding time N₁ [symbols] |
|---|---|
| 0/15 kHz | 3 |
| 1/30 kHz | 4.5 |
| 2/60 kHz | 9 for frequency range 1 |

TABLE 12

| u/SCS | PUSCH preparation time N₂ [symbols] |
|---|---|
| 0/15 kHz | 10 |
| 1/30 kHz | 12 |
| 2/60 kHz | 23 |
| 3/120 kHz | 36 |

TABLE 13

| u/SCS | PUSCH preparation time N₂ [symbols] |
|---|---|
| 0/15 kHz | 5 |
| 1/30 kHz | 5.5 |
| 2/60 kHz | 11 for frequency range 1 |

The UE may report a PDSCH processing capability supported thereby with respect to carriers corresponding to one band entry within a band combination to the BS. For example, the UE may report a UE capability regarding whether the UE supports PDSCH processing capability #1 only or supports PDSCH processing capability #2, with respect to each SCS supported in a corresponding band. The UE may report a PUSCH processing capability supported thereby with respect to carriers corresponding to one band entry within a band combination. For example, the UE may report a UE capability regarding whether the UE supports PUSCH processing capability #1 only or supports PUSCH processing capability #2, with respect to each SCS supported in a corresponding band.

If the UE configured to multiplex different UCI types within one PUCCH intends to transmit a plurality of overlapping PUCCHs in a slot or transmit overlapping PUCCH(s) and PUSCH(s) in a slot, the UE may multiplex the UCI types when specific conditions are fulfilled. The specific conditions may include multiplexing timeline condition(s). For example, PUCCH(s) and PUSCH(s) to which UCI multiplexing is applied in FIGS. 10 to 12 may be UL channels that satisfy the multiplexing timeline condition(s). Referring to FIG. 13, the UE may need to transmit a plurality of UL channels (e.g., UL channels #1 to #4) in the same slot. Here, UL CH #1 may be a PUSCH scheduled by PDCCH #1. UL CH #2 may be a PUCCH for transmitting HARQ-ACK for a PDSCH. The PDSCH is scheduled by PDCCH #2 and a resource of UL CH #2 may also be indicated by PDCCH #2.

In this case, if overlapping UL channels (e.g., UL channels #1 to #3) on the time axis satisfy the multiplexing timeline condition, the UE may perform UCI multiplexing for overlapping UL channels #1 to #3 on the time axis. For example, the UE may check whether the first symbol of UL CH #3 from the last symbol of the PDSCH satisfies the condition of T1. The UE may also check whether the first symbol of UL CH #3 from the last symbol of PDCCH #1 satisfies the condition of T2. If the multiplexing timeline condition is satisfied, the UE may perform UCI multiplex for UL channels #1 to #3. In contrast, if the earliest UL channel (e.g., UL channel having the earliest start symbol) among overlapping UL channels does not satisfy the multiplexing timeline condition, the UE may not be allowed to multiplex all of the corresponding UCI types.

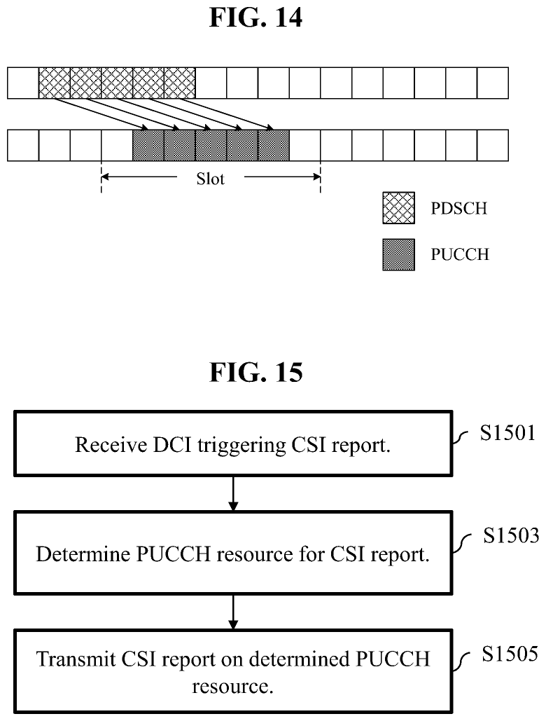

FIG. 14 illustrates transmission of a plurality of HARQ-ACK PUCCHs in a slot.

In some scenarios, it is regulated that a UE is not expected to transmit more than one PUCCH with HARQ-ACK information in a slot. Thus, according to these scenarios, the UE may transmit at most one PUCCH with HARQ-ACK information in one slot. In order to prevent a situation in which the UE fails to transmit the HARQ-ACK information due to restrictions on the number of HARQ-ACK PUCCHs transmittable by the UE, the BS needs to perform DL scheduling so that the HARQ-ACK information may be multiplexed on one PUCCH resource. However, when taking into consideration a service with stringent latency and reliability requirements, such as a URLLC service, a scheme of concentrating a plurality of HARQ-ACK feedbacks only on one PUCCH in a slot may not be desirable in terms of PUCCH performance. Furthermore, in order to support a latency-critical service, the BS may be required to schedule a plurality of consecutive PDSCHs with a short duration in one slot. Although the UE may transmit a PUCCH in random symbol(s) in a slot by the configuration/indication of the BS, if the UE is allowed to transmit only a maximum of one HARQ-ACK PUCCH in a slot, it may be impossible for the BS to perform fast back-to-back scheduling for PDSCHs and for the UE to perform fast HARQ-ACK feedback. Accordingly, in order to flexibly and efficiently use resources and support services, it is better to allow transmission of a plurality of (non-overlapping) HARQ-ACK PUCCHs (or PUSCHs) in one slot as illustrated in FIG. 14. Thus, in some scenarios, PUCCH feedback based on a subslot consisting of fewer (e.g., 2 or 7 OFDM symbols) than 14 OFDM symbols as well as PUCCH feedback based on a slot consisting of 14 OFDM symbols may be considered.

Separate codebooks may be formed/generated for HARQ-ACK feedback for a plurality of DL data channels (e.g., a plurality of PDSCHs) having different service types, different quality of service (QoS), different latency requirements, different reliability requirements, and/or different priorities. For example, a HARQ-ACK codebook for PDSCH(s) associated with high priority and a HARQ-ACK codebook for PDSCH(s) associated with low priority may be separately configured/formed. For HARQ-ACK feedback for PDSCHs with different priorities, different parameters and different resource configurations may be considered for PUCCH transmissions with different priorities (see the information element (IE) pucch-ConfigurationList of 3GPP TS 38.331). The unit of a time difference (e.g., a PDSCH-to-HARQ_feedback timing indicator) between a DL data channel and a PUCCH for HARQ-ACK feedback transmission may be determined by a predetermined subslot length (e.g., the number of symbols included in a subslot). For example, the unit of the time difference from the DL data channel to the PUCCH for HARQ-ACK feedback transmission may be configured by a parameter “subslotLengthForPUCCH” in PUCCH-Config, which is configuration information used to configure UE-specific PUCCH parameters. According to these scenarios, the length unit of the PDSCH-to-HARQ feedback timing indicator may be configured for each HARQ-ACK codebook.

In 3GPP-based systems, channel state information (CSI) may include the following indicators/reports: a channel quality indicator (CQI), preceding matrix indicator (PMI), CSI-RS resource indicator (CRI), SS/PBCH block resource indicator (SSBRI), layer indicator (LI), rank indicator (RI), layer-1 reference signal received power (L1-RSRP), or layer-1 signal to interference and noise ratio (L1-SINR). For the CQI, PMI, CRI, SSBRI, LI, RI, or L1-RSRP, the UE may be configured with N CSI-ReportConfig reporting settings (where N>=1), M CSI-ResourceConfig resource settings (where M>=1), and one or two list(s) of trigger states (given by higher layer parameters CSI-AperiodicTriggerStateList and CSI-SemiPersistentOnPUSCH-TriggerStateList). Each trigger state in CSI-AperiodicTriggerStateList includes a list of associated CSI-ReportConfigs indicating resource set IDs for channel and optionally for interference, and each trigger state in CSI-SemiPersistentOnPUSCH-TriggerStateList includes one associated CSI-ReportConfig.

There are three types of reporting: periodic CSI (P-CSI) reporting, semi-persistent CSI (SP-CSI) reporting, and aperiodic CSI (A-CSI) reporting. The UE performs CSI reporting based on an RRC configuration for the CSI reporting by the BS. The reporting configuration for CSI may be aperiodic (using a PUSCH), periodic (using a PUCCH), or semi-persistent (using a PUCCH and a DCI activated PUSCH).

In the prior art, A-CSI reporting using periodic PUCCH resources has not been considered. For example, in some scenarios (e.g., 3GPP NR Rel-16), A-CSI reporting on a PUCCH is triggered by DCI and performed over one PUCCH. When periodic PUCCH resources for CSI reporting are configured, P-CSI reporting on a PUCCH is enabled and performed on the periodic PUCCH. SP-CSI reporting on a PUSCH is performed on periodic PUSCH resources for CSI reporting and triggered by activation DCI triggering the SP-CSI reporting. SP-CSI reporting on a PUCCH is performed on periodic PUCCH resources and activated by an activation command through a MAC control element (CE).

Table 14 below shows supported combinations of CSI reporting configurations and CSI-RS resource configurations and how CSI reporting is triggered for each CSI-RS reporting configuration. A periodic CSI-RS may be configured by higher layers (e.g., RRC). A semi-persistent CSI-RS may be activated and deactivated as described in Section 5.2.1.5.2 of 3GPP TS 38.214. An aperiodic CSI-RS may be configured and triggered/deactivated as described in Section 5.2.1.5.1 of 3GPP TS 38.214.

TABLE 14

| CSI-RS | Periodic CSI | | Aperiodic CSI |
|---|---|---|---|
| Configuration | Reporting | Semi-Persistent CSI Reporting | Reporting |
| Periodic CSI- | No dynamic | For reporting on PUCCH, the UE | Triggered by DCI |
| RS | triggering/activation | receives an activation command; | |
| | | for reporting on PUSCH, the UE | |
| | | receives triggering on DCI | |
| Semi- | Not Supported | For reporting on PUCCH, the UE | Triggered by DCI |
| Persistent CSI- | | receives an activation command; | |
| RS | | for reporting on PUSCH, the UE | |
| | | receives triggering on DCI | |
| Aperiodic CSI- | Not Supported | Not Supported | Triggered by DCI |
| RS | | | |

In some scenarios (e.g., 3GPP-based 3GPP systems up to 3GPP NR Rel-16), the UE needs to use a PUSCH resource to transmit A-CSI information to the BS. To allocate such a PUSCH resource, the BS needs to transmit a UL grant to the UE. This series of operations may require an additional UL grant and an additional PUSCH resource for every CSI transmission in order to adapt the quality of DL transmission. This operation may not only waste unnecessary UL resources because the BS needs to schedule a PUSCH even when the UE has no UL traffic to transmit but also cause a PDCCH blocking problem because limited PDCCH occasions of the UE are used to schedule a UL grant for A-CSI reporting.

The present disclosure describes implementations in which the UE transmits an A-CSI report, which is triggered in DCI, on PUCCH resources. For example, the present disclosure describes methods and procedures for determining resources for transmitting CSI information and methods and procedures for improving the accuracy and processing time of the CSI information transmitted on the corresponding resources. In some implementations of the present disclosure, the DCI triggering A-CSI reporting may be UL scheduling DCI. In some implementations of the present disclosure, the DCI triggering A-CSI reporting may be DL scheduling DCI.

In some implementations of the present disclosure, method(s) of efficiently selecting a PUCCH carrying CSI without causing any additional time delay to PDSCH transmission and method(s) and procedure(s) for more efficiently configuring and changing the CSI to be transmitted when not only PDSCH reception but also A-CSI transmission are triggered in DL scheduling DCI and when the A-CSI transmission is performed on the PUCCH will be described in order to perform link adaptation for DL with no additional PUSCH scheduling.

UE Side:

When the UE is configured with higher layer parameter(s) required for A-CSI transmission and receives DCI, the UE may perform the A-CSI transmission on a PUCCH resource based on some implementations of the present disclosure. For example, in some implementations of the present disclosure, the UE may operate as follows.

The UE may receive one or more RRC configurations for the A-CSI transmission from the BS. The RRC configurations may be received for each A-CSI configuration. The UE may be scheduled by the BS to receive a PDSCH. In this case, information triggering CSI may be added to DCI scheduling the PDSCH reception and then transmitted. The information triggering CSI may be provided according to one of the following methods.
A separate field triggering CSI transmission may be added to DCI.
Specific resource allocation information (e.g., entries of a TDRA table, the most significant bit (MSB) or least significant bit (LSB) of an FDRA field, etc.) may indicate CSI transmission.
When DCI indicates retransmission, that is, when a new data indicator (NDI) in the DCI is toggled in comparison with information stored in a HARQ entity, it may be assumed that CSI transmission is triggered.
A MAC CE included in a UL-SCH, which is received based on a PDSCH, may indicate CSI transmission.
When a priority indicator included in DCI has a specific value, it may be assumed that CSI transmission is triggered.

The UE may transmit the CSI on the PUCCH resource based on the DCI transmitted from the BS. In this case, according to some implementations of the present disclosure, one of the following may be selected as the PUCCH resource:
The same resource as that of a PUCCH carrying the HARQ-ACK for a PDSCH scheduled by DCI; or
A PUCCH resource determined based on the configuration of triggered CSI.

To transmit the CSI, the UE may selectively update information on a CQI, RI, and PMI based on some implementations of the present disclosure.

When transmitting the CSI, the UE may selectively include the information on the CQI, RI, and PMI in the entire CSI information based on some implementations of the present disclosure.

For example, in some implementations of the present disclosure, the following UE operation(s) may be considered.

<Implementation A1> PUCCH Resource Selection for A-CSI on PUCCH

The UE may be scheduled by the BS to receive a PDSCH. In this case, information triggering CSI may be included in DCI scheduling the PDSCH and then received. The information triggering CSI may be provided by the BS to the UE according to one of the following methods.
A separate field triggering CSI transmission may be added to DCI. When this method is used, the size of a specific DL scheduling DCI format supporting CSI triggering may vary. In particular, when DL scheduling DCI supports the CSI triggering only if a codebook with a specific priority is used, or when a different CSI triggering state is used depending on the priority of a used codebook, the separate field may have a different length, and thus there may be different DCI sizes. Accordingly, when this method is used, one of the following methods may be additionally considered to obtain the same DCI size, regardless of whether CSI is triggered or not.
   The CSI triggering field may be provided by the MSB or LSB of an existing DCI field. In this case, among DCI fields each requiring a different bit length for each priority, a preceding field having a smaller DCI length in the priority of the corresponding DCI than in other priorities may be used. For example, when a field length required for indicating a lower priority (LP) is different from a field length required for indicating a higher priority (LP), a DCI format may be configured based on the longer of the two field lengths. If several fields among fields constituting the DCI format require different lengths according to priorities, a field positioned at the front in the corresponding DCI format among fields in which some bits are not used may be used for CSI triggering because the currently indicated priority requires a short length field.
   When the separate field triggering CSI transmission is added to the DCI, zero padding may be performed at the end of a DCI format of a priority with a smaller DCI length according to the length of a DCI format of a priority with a larger DCI length until the smaller DCI length becomes the same as the larger DCI length.
Specific resource allocation information (e.g., entries of a TDRA table, the MSB or LSB of an FDRA field, etc.) may indicate CSI transmission.
When DCI indicates retransmission, that is, when an NDI in the DCI is toggled in comparison with information stored in a HARQ entity, it may be assumed that CSI transmission is triggered.
A MAC CE included in a UL-SCH, which is received based on a PDSCH, may indicate CSI transmission.
When a priority indicator included in DCI has a specific value, it may be assumed that CSI transmission is triggered.

FIG. 15 illustrates a CSI transmission process according to some implementations of the present disclosure.

The UE may receive DCI triggering a CSI report over a PUCCH (S1501). In some implementations, the CSI report may be A-CSI. In some implementations, the DCI may be DL scheduling DCI scheduling a PDSCH.

The UE may determine a PUCCH resource for the CSI report (S1503) and transmit the CSI report on the determined PUCCH resource (S1505).

In some implementations of the present disclosure, a PUCCH resource for transmitting CSI triggered by DL scheduling DCI may be determined as follows.

<Implementation A1-1> Using Periodic PUCCH Occasion

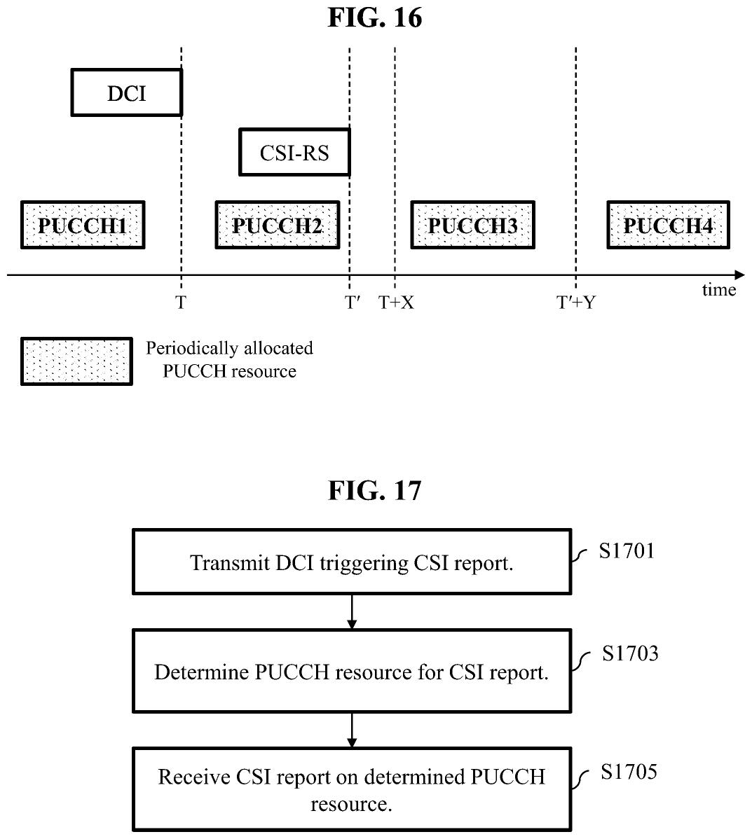

FIG. 16 illustrates PUCCH resources available for A-CSI triggered by DCI according to some implementations of the present disclosure. In the example of FIG. 16, PUCCH1 to PUCCH4 represent PUCCH resources according to a periodic PUCCH configuration, where PUCCH1 precedes PUCCH2 in time, PUCCH2 precedes PUCCH3 in time, and PUCCH3 precedes PUCCH4 in time.

The periodicity and offset of a PUCCH resource may be determined by a CSI configuration associated with triggered CSI, which may be given by an existing parameter CSI-ReportPeriodicityAndOffset. When T is a point in time at which DCI triggering CSI is received and X is a minimum CSI computation time from DCI reception, the UE may use a PUCCH resource that occurs after the point in time T+X. For example, the UE may transmit the CSI on a PUCCH resource configured in a slot starting after the point in time T+X. Alternatively, the UE may use the first PUCCH resource that occurs after the point in time T+X among PUCCH resources determined in consideration of the payload of the CSI. Referring to FIG. 16, PUCCH3 is used to report the CSI triggered by the DCI. In some implementations, T+X may be Z_{ref} defined in Section 5.4 of 3GPP TS 38.214. Referring to Section 5.4 of 3GPP TS 38.214, when CSI report(s) are triggered by a CSI request field in DCI, i) if the first UL symbol for carrying the corresponding CSI report(s) including the effect of timing advance does not start earlier than at symbol Z_{ref}, and ii) if the first symbol for carrying an n-th report including the effect of timing advance does not start earlier than at Z′_{ref}(n), the UE may provide a valid CSI report for the n-th triggered report. Herein, Z_{ref} is defined as a next UL symbol with a CP starting after T_{proc,CSI}=(Z)*(2048+144)*κ*2^{-u}*T_{c}+T_{switch} from the end of the last symbol of a PDCCH triggering the CSI report(s), and Z′_{ref} is defined as a next UL symbol with a CP starting after T′_{proc,CSI}=(Z′)*(2048+144)*κ*2^{-u}*T_{c} from the end of the last symbol of the latest in time of the following: A-CSI-RS for channel measurements; aperiodic channel state information interference measurement (A-CSI-IM) used for interference measurements; and aperiodic non-zero power (NZP) CSI-RS for interference measurement, when the A-CSI-RS is used for channel measurement for the n-th triggered CSI report. In this case, T_{switch} may be applied only when Z₁ in Table 15 below is applied. The conditions of applying Z₁ may be found in Section 5.4 of 3GPP TS 38.214.

TABLE 15

Z₁ [symbols]

| u | Z₁ | Z′₁ |
|---|---|---|
| 0 | 10 | 8 |
| 1 | 13 | 11 |
| 2 | 25 | 21 |
| 3 | 43 | 36 |

When a CSI-RS associated with the triggered CSI is received at a specific point in time T′ after a slot in which the DCI triggering CSI is received, and when Y is a minimum CSI computation time from CSI-RS reception, the UE may expect that the PUCCH resource occurs after the point in time T′+Y. Referring to FIG. 16, PUCCH4 is used to report the CSI triggered by the DCI. Alternatively, the UE may not expect that the PUCCH resource occurs before the point in time T′+Y. Here, T′+Y may be Z′_{ref} defined in Section 5.4 of 3GPP TS 38.213.

For a periodic CSI-RS, it is difficult for the BS to trigger A-CSI reporting by adjusting the CSI-RS transmission timing. Thus, in some implementations of the present disclosure, the UE may use the minimum CSI computation time from DCI reception and the minimum CSI computation time from CSI-RS reception to select a PUCCH resource for the A-CSI reporting. For example, when the CSI-RS associated with the triggered CSI is configured to be transmitted periodically, if T′ is a point in time at which the first CSI-RS is received and Y is a minimum CSI calculation time from CSI-RS reception, the UE may use a PUCCH resource occurring after the later of the point in time T+X and the point in time T′+Y. Referring to FIG. 16, for example, PUCCH4 is used to report the CSI triggered by the DCI. As described above, T+X may be Z_{ref} defined in Section 5.4 of 3GPP TS 38.213, and T′+Y may be Z′_{ref} defined in Section 5.4 of 3GPP TS 38.213.

<Implementation A1-2> Using HARQ-ACK PUCCH if it is Possible

The UE may use a PUCCH resource according to specific conditions, which is indicated by DL scheduling DCI that triggers CSI through a PUCCH resource indicator (PRI) and a PDSCH-to-HARQ_feedback timing indicator, in order to transmit the triggered CSI. In this case, the following conditions may be considered:
When T is a point in time at which DCI triggering CSI is received and X is a minimum CSI computation time from DCI reception, the point in time T+X is before the first symbol of a PUCCH indicated by the PRI and PDSCH-to-HARQ_feedback timing indicator; and
When a CSI-RS associated with the triggered CSI is received at a specific point in time T′ after a slot in which the DCI triggering CSI is received, and when a minimum CSI computation time from CSI-RS reception is Y, the point in time T′+Y is before the first symbol of the PUCCH indicated by the PRI and PDSCH-to-HARQ_feedback timing indicator.

If the PUCCH indicated by DL scheduling satisfies the above two conditions, the UE may perform the triggered CSI transmission triggered on the PUCCH. If the PUCCH does not satisfy the two conditions, the UE may perform the triggered CSI transmission on a PUCCH resource determined based on an associated CSI configuration.

<Implementation A2> Subband Based Reporting and Adaptation

In some implementations, the UE may divide an entire BWP into about 3 to 19 subbands according to a given CSI report configuration and transmit CSI information in each subband. The configurations of these subbands may be determined based on RRC configurations of the BS and the BWP size. The BS may instruct the UE to perform reporting only on some subband(s) among the 3 to 19 subbands. For example, the BS may provide an RRC configuration that indicates subband(s) where CSI is to be reported among all subbands in a bitmap.

In some implementations of the present disclosure, to improve the accuracy/reliability of CSI through CSI computation time reduction and payload reduction, the UE may report CSI for some random subband(s) among all subbands or in a group of subbands where CSI transmission is indicated by the BS. For example, the UE may transmit CSI reports for M subbands having the best channel state or the worst channel state among all subbands or in the group of subbands configured by the BS. The M subbands having the best channel state or the worst channel state may be determined as follows.
The M subbands may be arbitrarily determined depending on the implementation of the UE.
Subbands with the highest CQI value or the lowest CQI value.
Subbands with the highest RI value or the lowest RI value.
Subbands with the highest or lowest measured SINR/RSRP value and/or the highest or lowest reference signal received quality (RSRQ) value.
Subbands with the highest or lowest measured interference level.

When the BS sets each bit of a bitmap with a length of X, where each bit is associated with Y subband(s), and configure the bitmap to the UE in order to receive CSI for the Y subband(s) among a total of X subbands, the UE may include a bitmap with a length of Y in a CSI report and transmit the CSI report in order to indicate subband(s) where the CSI reporting is actually performed among the configured Y subbands. The UE may set bit(s) associated with the subband(s) in which the UE transmits/updates the CSI to 1 and then transmit the bit(s).

<Implementation A2-1>

When CSI transmission is performed in units of subbands as in Implementation A2 or in a similar way, a group of subbands may be dynamically changed through L1 signaling and/or L2 signaling from the BS. For example, the following method(s) may be considered.
Two or more subband groups may configured through higher layer signaling from the BS, and a subband group used for CSI transmission of the two or more subband groups may be indicated by one of the fields of DCI triggering CSI.
A list of A-CSI trigger states, which may be indicated in DL scheduling DCI, may be configured through higher layer signaling from the BS, and each CSI trigger state included in the A-CSI trigger state list may be configured to use a different subband group.
A subband for a next CSI report or a subband for a CSI report associated with a specific CSI configuration may be changed by a MAC CE. In this case, the following MAC CE may be considered.

The MAC CE may include one or more subband indices. The UE may add subband(s) associated with the one or more subband indices to the subband group. If there are subbands that have already been added, the subbands may be excluded from the subband group. Alternatively, a 1-bit flag indicating exclusion or addition may be given for each subband index or for all subband indices included in the MAC CE.

The MAC CE may include a bitmap for representing all subbands. The BS or UE may set bit(s) associated with subband(s) used for a CSI report to 1 in order to represent the bit(s) in the bitmap. The MAC CE may be transmitted by the BS to configure the subband(s) to be included in a CSI report, or the MAC CE may be transmitted to inform the indices of subband(s) used for a CSI report previously transmitted from the UE.

<Implementation A3> Selective CSI Report/Update

To improve the accuracy of CSI by reducing the time interval between a CSI RS and a CSI report through reduction of the CSI computation time of the UE, CSI may be updated only for some random subbands among all subbands or in a group of subbands for which CSI transmission is indicated by the BS, based on previous CSI. Alternatively, CSI may be transmitted only for some subbands. For example, the UE may transmit/update CSI only for M subband(s) having the best channel state in the previous CSI among all subbands or in the subband group configured by the BS. Alternatively, the UE may transmit/update CSI only for M subband(s) having the worst channel state in the previous CSI. Further, the UE may transmit/update CSI only for the remaining subband(s) except for the M subband(s) having the worst channel state in the previous CSI. The M subband(s) having the best channel state or the worst channel state may be determined according to the method(s) defined in Implementation A2.

Alternatively, to improve the CSI accuracy by reducing the CSI computation time of the UE, the entirety of CSI (e.g., CQI, RI, PMI, etc.) may be updated for some random subband(s) among all subband(s) or in a group of subbands which CSI transmission is indicated by the BS based on previous CSI, but for the remaining subband(s), CSI reporting may be performed by updating only part of the CSI (e.g., CQI). In one example, the UE may update all information of CSI for M subband(s) having the highest CQI value and/or the highest RI value in previous CSI among all subbands or in the subband group configured by the BS, but the UE may perform CSI reporting by updating only part of the CSI for the remaining subband(s). In some implementations, only updated CSI may be transmitted when the CSI reporting is performed. In another example, the UE may update part of CSI for M subband(s) having the lowest CQI value and/or the lowest RI value in the previous CSI among all subbands or in the subband group configured by the BS, but the UE may perform CSI reporting by updating the entire CSI for the remaining subband(s). In some implementations, when CSI reporting is performed, only updated CSI may be transmitted.

According to this method, CSI updating may be skipped for a low quality channel that is unlikely to be allocated by the BS to the UE, thereby reducing the burden of CSI processing on the UE. Accordingly, the UE may transmit CSI for M best or worst subbands based on a previous CSI report without measuring all subbands in a corresponding CSI report, thereby reducing the time required for CSI computation. This may reduce the time from a CSI-RS to the CSI report, resulting in improving the CSI accuracy. When Implementation A3 is applied, the UE may use a separate CSI computation time or apply an additional reporting time offset, so that the UE may perform CSI reporting with a shorter time delay. In some implementations, the capability of the UE to determine whether the above operation is enabled may be signaled.

<Implementation A3-1> Whole Sub-Band CSI Measurement Timer

When Implementation A3 is used, CSI for all subbands or a group of subbands for which CSI transmission is indicated by the BS may be updated and reported at regular intervals, regardless of previous CSI report values. For example, upon CSI reporting, the UE may start a specific timer, timer X associated with each CSI report configuration. Then, the UE may perform the operations of Implementation A3 for the corresponding CSI report until timer X expires. When timer X expires and the corresponding CSI report is triggered, the UE may update the CSI for all subbands or subband group for which the CSI transmission is indicated by the BS and perform the CSI reporting without using Implementation A3. After successfully reporting the CSI, the UE may restart timer X.

The UE may update and report the CSI for all subbands or subband group for which the CSI transmission is indicated by to the BS at least for each time duration of timer X through a series of processes. Accordingly, even if Implementation A3 is applied, it is possible to avoid a case in which only CSI for a specific subband is continuously updated. In addition, the BS may adjust the trade-off between saving the CSI computation time and updating the CSI for all subbands based on the time duration of timer X.

<Implementation A3-2> Separated CSI Computation Time

According to Implementation A3, the UE may substantially reduce the time required for CSI computation by updating CSI only for some subband(s). To reflect the reduced CSI computation time to CSI triggering by the BS, a separate CSI computation time table used when CSI updating and reporting is performed for only some subband(s) may be defined as in Implementation A3 or in a similar way.

A minimum required CSI computation time obtained from the CSI computation time table may be configured with the following two values minimum CSI computation time from CSI-RS reception and minimum CSI computation time from PDCCH triggering CSI. The CSI computation time table may include a different minimum required CSI computation time for each value indicating a different SCS. The minimum required CSI computation time may be selected based on the smallest value among the SCS of a PDCCH triggering CSI, the SCS of a BWP for transmitting a CSI-RS, and the SCS of a UL channel carrying a CSI report.

Additionally, depending on the number of subbands used for CSI reporting, in particular, the number of subbands for which the entirety of CSI is updated, different minimum required CSI computation times may be obtained from the CSI computation time table. For example, the CSI computation time table may include different minimum required CSI computation times, depending on the used SCS and the number of subbands for which CSI is updated. The minimum required CSI computation times may be selected based on the number of subbands for which the CSI is updated and the smallest value among the SCS of the PDCCH triggering the CSI, the SCS of the BWP for transmitting the CSI-RS, and the SCS of the UL channel carrying the CSI report.

BS Side:

The BS may provide to the UE higher layer parameter(s) required for A-CSI transmission and trigger A-CSI transmission on a PUCCH resource in DCI based on some implementations of the present disclosure. For example, in some implementations of the present disclosure, the BS may operate as follows.

The BS may transmit one or more RRC configurations for the A-CSI transmission to the UE. The RRC configurations may be transmitted for each A-CSI configuration. The BS may schedule PDSCH reception to the UE. In this case, information triggering CSI may be added to DCI scheduling the PDSCH reception and then transmitted. The information triggering CSI may be provided according to one of the following methods.
A separate field triggering CSI transmission may be added to DCI.
Specific resource allocation information (e.g., entries of a TDRA table, the MSB or LSB of an FDRA field, etc.) may indicate CSI transmission.
When DCI indicates retransmission, that is, when an NDI in the DCI is toggled in comparison with information stored in a HARQ entity, it may be assumed that CSI transmission is triggered.
A MAC CE included in a UL-SCH, which is received based on a PDSCH, may indicate CSI transmission.
When a priority indicator included in DCI has a specific value, it may be assumed that CSI transmission is triggered.

The BS may receive a CSI report, which is triggered by the transmitted DCI, on the PUCCH resource. In this case, according to some implementations of the present disclosure, one of the following may be selected as the PUCCH resource:
The same resource as that of a PUCCH carrying the HARQ-ACK for a PDSCH scheduled by DCI; or
A PUCCH resource determined based on the configuration of triggered CSI.

When the BS receives CSI from the UE, the BS may assume that the UE may selectively update information on a CQI, RI, and PMI based on some implementations of the present disclosure.

When the BS receives the CSI from the UE, the BS may assume that the UE selectively includes the information on the CQI, RI, and PMI in the entire CSI information based on some implementations of the present disclosure.

For example, in some implementations of the present disclosure, the following BS operation(s) may be considered.

<Implementation B1> PUCCH Resource Selection for A-CSI on PUCCH

The BS may schedule PDSCH reception to the UE. In this case, information triggering CSI may be included in DCI scheduling the PDSCH and then transmitted. The information triggering CSI may be provided by the BS to the UE according to one of the following methods.
A separate field triggering CSI transmission may be added to DCI. When this method is used, the size of a specific DL scheduling DCI format supporting CSI triggering may vary. In particular, when DL scheduling DCI supports the CSI triggering only if a codebook with a specific priority is used, or when a different CSI triggering state is used depending on the priority of a used codebook, the separate field may have a different length, and thus, there may be different DCI sizes. Accordingly, when this method is used, one of the following methods may be additionally considered to obtain the same DCI size, regardless of whether CSI is triggered or not.
   The CSI triggering field may be provided by the MSB or LSB of an existing DCI field. In this case, among DCI fields each requiring a different bit length for each priority, a preceding field having a smaller DCI length in the priority of the corresponding DCI than in other priorities may be used. For example, when a field length required for indicating an LP is different from a field length required for indicating an LP, a DCI format may be configured based on the longer of the two field lengths. If several fields among fields constituting the DCI format require different lengths according to priorities, a field positioned at the front in the corresponding DCI format among fields in which some bits are not used may be used for CSI triggering because the currently indicated priority requires a short length field.
   When the separate field triggering CSI transmission is added to the DCI, zero padding may be performed at the end of a DCI format of a priority with a smaller DCI length according to the length of a DCI format of a priority with a larger DCI length until the smaller DCI length becomes the same as the larger DCI length.
Specific resource allocation information (e.g., entries of a TDRA table, the MSB or LSB of an FDRA field, etc.) may indicate CSI transmission.
When DCI indicates retransmission, that is, when an NDI in the DCI is toggled in comparison with information stored in a HARQ entity, it may be assumed that CSI transmission is triggered.
A MAC CE included in a UL-SCH, which is received based on a PDSCH, may indicate CSI transmission.
When a priority indicator included in DCI has a specific value, it may be assumed that CSI transmission is triggered.

FIG. 17 illustrates a CSI transmission process according to some implementations of the present disclosure.

The BS may transmit DCI triggering a CSI report to the UE over a PUCCH (S1701). In some implementations, the CSI report may be A-CSI. In some implementations, the DCI may be DL scheduling DCI scheduling a PDSCH.

The BS may determine a PUCCH resource for the CSI report (S1603) and receive the CSI report on the determined PUCCH resource (S1605).

In some implementations of the present disclosure, a PUCCH resource for transmitting CSI triggered by DL scheduling DCI may be determined as follows.

<Implementation B1-1> Using Periodic PUCCH Occasion

The periodicity and offset of a PUCCH resource may be determined by a CSI configuration associated with triggered CSI, which may be given by an existing parameter CSI-ReportPeriodicityAndOffset. When T is a point in time at which DCI triggering CSI is received and X is a minimum CSI computation time from DCI reception, the BS may assume that the UE uses a PUCCH resource that occurs after the point in time T+X. Then, the BS may attempt to receive CSI transmission triggered to the UE on the PUCCH resource. For example, the BS may receive the CSI from the UE on a PUCCH resource configured for the UE in a slot starting after the point in time T+X. Alternatively, the BS may receive the CSI from the UE on the first PUCCH resource that occurs after the point in time T+X among PUCCH resources determined in consideration of the payload of the CSI. Referring to FIG. 16, for example, the BS may use PUCCH3 to receive the CSI report triggered by the DCI. In some implementations, T+X may be Z_{ref} defined in Section 5.4 of 3GPP TS 38.214.

When a CSI-RS associated with the triggered CSI is transmitted to the UE at a specific point in time T′ after a slot in which the DCI triggering CSI is transmitted, and when Y is a minimum CSI computation time from CSI-RS reception, the BS may assume that the UE expects that the PUCCH resource occurs after the point in time T′+Y and then attempt to receive the CSI from the UE. Referring to FIG. 16, for example, the BS may use PUCCH4 to receive the CSI report triggered by the DCI. Alternatively, the BS may trigger a related CSI report to the UE such that the PUCCH resource does not occur before the point in time T′+Y. Here, T′+Y may be Z′_{ref} defined in Section 5.4 of 3GPP TS 38.213.

For a periodic CSI-RS, it is difficult for the BS to trigger A-CSI reporting by adjusting the CSI-RS transmission timing. Thus, in some implementations of the present disclosure, the UE may use the minimum CSI computation time from DCI reception and the minimum CSI computation time from CSI-RS reception to select a PUCCH resource for the A-CSI reporting. For example, when the CSI-RS associated with the triggered CSI is configured to be transmitted periodically, if T′ is a point in time at which the first CSI-RS is received after DCI reception and Y is a minimum CSI calculation time from CSI-RS reception, the BS may assume that the UE will use a PUCCH resource occurring after the later of the point in time T+X and the point in time T′+Y. Referring to FIG. 16, for example, the BS may use PUCCH4 to receive the CSI report triggered by the DCI. As described above, T+X may be Z_{ref} defined in Section 5.4 of 3GPP TS 38.213, and T′+Y may be Z′ ref defined in Section 5.4 of 3GPP TS 38.213.

<Implementation B1-2> Using HARQ-ACK PUCCH if it is Possible

The BS may use a PUCCH resource according to specific conditions, which is indicated by DL scheduling DCI that triggers CSI through a PRI and a PDSCH-to-HARQ_feedback timing indicator, in order to receive the CSI triggered to the UE. In this case, the following conditions may be considered:
When T is a point in time at which DCI triggering CSI is received and X is a UE's minimum CSI computation time from DCI reception, the point in time T+X is before the first symbol of a PUCCH indicated by PRI and PDSCH-to-HARQ_feedback timing indicator; and
When a CSI-RS associated with the triggered CSI is transmitted at a specific point in time T after a slot in which the DCI triggering CSI is transmitted, and when a UE's minimum CSI computation time from CSI-RS reception is Y, the point in time T′+Y is before the first symbol of the PUCCH indicated by the PRI and PDSCH-to-HARQ_feedback timing indicator.

If the PUCCH indicated by DL scheduling satisfies the above two conditions, the BS may receive a CSI report triggered to the UE on the PUCCH. If the PUCCH does not satisfy the two conditions, the BS may receive the CSI report triggered to the UE on a PUCCH resource determined based on an associated CSI configuration.

<Implementation B2> Subband Based Reporting and Adaptation

In some implementations, the UE may divide an entire BWP into about 3 to 19 subbands according to a given CSI report configuration and transmit CSI information in each subband. The configurations of these subbands may be determined based on RRC configurations of the BS and the BWP size. The BS may instruct the UE to perform reporting only on some subband(s) among the 3 to 19 subbands. For example, the BS may provide an RRC configuration that indicates subband(s) where CSI is to be reported among all subbands in a bitmap.

In some implementations of the present disclosure, to improve the accuracy/reliability of CSI through CSI computation time reduction and payload reduction, the UE may report CSI for some random subband(s) among all subbands or in a group of subbands where CSI transmission is indicated by the BS. For example, the UE may transmit CSI reports for M subbands having the best channel state or the worst channel state among all subbands or in the group of subbands configured by the BS. The M subbands having the best channel state or the worst channel state may be determined as follows.
The M subbands may be arbitrarily determined depending on the implementation of the UE.
Subbands with the highest CQI value or the lowest CQI value.
Subbands with the highest RI value or the lowest RI value.
Subbands with the highest or lowest measured SINR/RSRP value and/or the highest or lowest RSRQ value.
Subbands with the highest or lowest measured interference level.

When the BS sets each bit of a bitmap with a length of X, where each bit is associated with Y subband(s), and configure the bitmap to the UE in order to receive CSI for the Y subband(s) among a total of X subbands, the UE may include a bitmap with a length of Y in a CSI report and transmit the CSI report in order to indicate subband(s) where the CSI reporting is actually performed among the configured Y subbands. The UE may set bit(s) associated with the subband(s) in which the UE transmits/updates the CSI to 1 and then transmit the bit(s).

<Implementation B2-1>

When CSI transmission is performed in units of subbands as in Implementation B2 or in a similar way, a group of subbands may be dynamically changed through L1 signaling and/or L2 signaling from the BS. For example, the following method(s) may be considered.
Two or more subband groups may configured through higher layer signaling from the BS, and a subband group used for CSI transmission of the two or more subband groups may be indicated by one of the fields of DCI triggering CSI.
A list of A-CSI trigger states, which may be indicated in DL scheduling DCI, may be configured through higher layer signaling from the BS, and each CSI trigger state included in the A-CSI trigger state list may be configured to use a different subband group.
A subband for a next CSI report or a subband for a CSI report associated with a specific CSI configuration may be changed by a MAC CE. In this case, the following MAC CE may be considered.

The MAC CE may include one or more subband indices. The UE may add subband(s) associated with the one or more subband indices to the subband group. If there are subbands that have already been added, the subbands may be excluded from the subband group. Alternatively, a 1-bit flag indicating exclusion or addition may be given for each subband index or for all subband indices included in the MAC CE.

The MAC CE may include a bitmap for representing all subbands. The BS or UE may set bit(s) associated with subband(s) used for a CSI report to 1 in order to represent the bit(s) in the bitmap. The MAC CE may be transmitted by the BS to configure the subband(s) to be included in a CSI report, or the MAC CE may be transmitted to inform the indices of subband(s) used for a CSI report previously transmitted from the UE.

<Implementation B3> Selective CSI Report/Update

To improve the accuracy of CSI by reducing the time interval between a CSI RS and a CSI report through reduction of the CSI computation time of the UE, CSI may be updated only for some random subbands among all subbands or in a group of subbands for which CSI transmission is indicated by the BS, based on previous CSI. Alternatively, CSI may be transmitted only for some subbands. For example, the UE may transmit/update CSI only for M subband(s) having the best channel state in the previous CSI among all subbands or in the subband group configured by the BS. Alternatively, the UE may transmit/update CSI only for M subband(s) having the worst channel state in the previous CSI. Further, the UE may transmit/update CSI only for the remaining subband(s) except for the M subband(s) having the worst channel state in the previous CSI. The M subband(s) having the best channel state or the worst channel state may be determined according to the method(s) defined in Implementation B2.

Alternatively, to improve the CSI accuracy by reducing the CSI computation time of the UE, the entirety of CSI (e.g., CQI, RI, PMI, etc.) may be updated for some random subband(s) among all subband(s) or in a group of subbands which CSI transmission is indicated by the BS based on previous CSI, but for the remaining subband(s), CSI reporting may be performed by updating only part of the CSI (e.g., CQI). In one example, the UE may update all information in CSI for M subband(s) having the highest CQI value and/or the highest RI value in previous CSI among all subbands or in the subband group configured by the BS, but the UE may perform CSI reporting by updating only part of the CSI for the remaining subband(s). In some implementations, only updated CSI may be transmitted when the CSI reporting is performed. In another example, the UE may update part of CSI for M subband(s) having the lowest CQI value and/or the lowest RI value in the previous CSI among all subbands or in the subband group configured by the BS, but the UE may perform CSI reporting by updating the entire CSI for the remaining subband(s). In some implementations, when CSI reporting is performed, only updated CSI may be transmitted.

According to this method, CSI updating may be skipped for a low quality channel that is unlikely to be allocated by the BS to the UE, thereby reducing the burden of CSI processing on the UE. Accordingly, the UE may transmit CSI for M best or worst subbands based on a previous CSI report without measuring all subbands in a corresponding CSI report, thereby reducing the time required for CSI computation. This may reduce the time from a CSI-RS to the CSI report, resulting in improving the CSI accuracy. When Implementation B3 is applied, the UE may use a separate CSI computation time or apply an additional reporting time offset, so that the UE may perform CSI reporting with a shorter time delay. In some implementations, the capability of the UE to determine whether the above operation is enabled may be signaled.

<Implementation B3-1> Whole Sub-Band CSI Measurement Timer

When Implementation B3 is used, CSI for all subbands or a group of subbands for which CSI transmission is indicated by the BS may be received and updated at regular intervals, regardless of previous CSI report values. For example, upon receiving a CSI report, the BS may start a specific timer, timer X associated with each CSI report configuration. Then, the BS may perform the operations of Implementation B3 for the corresponding CSI report until timer X expires. When timer X expires and the corresponding CSI report is triggered, the BS may receive updated CSI reports for all subbands or subband group for which the CSI transmission is indicated by the BS without using Implementation B3. After successfully receiving the CSI report, the BS may restart timer X.

The BS may receive the updated CSI reports for all subbands or subband group for which the CSI transmission is indicated by to the BS at least for each time duration of timer X through a series of processes. Accordingly, even if Implementation B3 is applied, it is possible to avoid a case in which only CSI for a specific subband is continuously updated. In addition, the BS may adjust the trade-off between saving the CSI computation time and updating the CSI for all subbands based on the time duration of timer X.

<Implementation B3-2> Separated CSI Computation Time

According to Implementation B3, the UE may be configured to update CSI only for some subband(s), thereby substantially reducing the time required for CSI computation. To reflect the reduced CSI computation time to CSI triggering by the BS, a separate CSI computation time table used when CSI is received for only some subband(s) may be defined as in Implementation B3 or in a similar way.

When the BS indicates or configures a CSI-RS and a CSI report to the UE, the BS may indicate and configure the CSI-RS and CSI report in consideration of the separate CSI computation time table such that a minimum required processing time between the CSI-RS and the CSI report and a minimum required processing time between DCI triggering the CSI report and the CSI report are guaranteed.

A minimum required CSI computation time obtained from the CSI computation time table may be configured with the following two values minimum CSI computation time from CSI-RS reception and minimum CSI computation time from PDCCH triggering CSI. The CSI computation time table may include a different minimum required CSI computation time for each value indicating a different SCS. The minimum required CSI computation time may be selected based on the smallest value among the SCS of a PDCCH triggering CSI, the SCS of a BWP for transmitting a CSI-RS, and the SCS of a UL channel carrying transmitting a CSI report.

Additionally, depending on the number of subbands used for CSI reporting, in particular, the number of subbands for which the entirety of CSI is updated, different minimum required CSI computation times may be obtained from the CSI computation time table. For example, the CSI computation time table may include different minimum required CSI computation times, depending on the used SCS and the number of subbands for which CSI is updated. The minimum required CSI computation times may be selected based on the number of subbands for which the CSI is updated and the smallest value among the SCS of the PDCCH triggering the CSI, the SCS of the BWP for transmitting the CSI-RS, and the SCS of the UL channel carrying the CSI report.

In some implementations of the present disclosure, the UE and BS may trigger a CSI report in DL scheduling DCI and determine a PUCCH resource to be used for the CSI report. When the BS indicates CSI reports for some subband(s), the UE may update and report CSI only for the subband(s) based on some implementations of the present disclosure, and the BS may receive the CSI reports on the assumption thereof.

According to some implementations of the present disclosure, the UE may select a PUCCH resource used to transmit a CSI report such that there is no additional time delay in PDSCH transmission. In some implementations of the present disclosure, the BS may configure subband CSI reporting to the UE so that the CSI reporting delay time may be reduced compared to the prior art, thereby increasing the accuracy of CSI and efficiently using radio resources.

For transmission of a CSI report, the UE may perform operations according to some implementations of the present disclosure. The UE may include: at least one transceiver; at least one processor; and at least one computer memory operably connected to the at least one processor and configured to store instructions that, when executed, cause the at least one processor to perform the operations according to some implementations of the present disclosure. A processing device for the UE may include: at least one processor; and at least one computer memory operably connected to the at least one processor and configured to store instructions that, when executed, cause the at least one processor to perform the operations according to some implementations of the present disclosure. A computer-readable (non-volatile) storage medium may be configured to store at least one computer program including instructions that, when executed by at least one processor, cause the at least one processor to perform the operations according to some implementations of the present disclosure. A computer program or computer program product may include instructions stored on at least one computer-readable (non-volatile) storage medium and, when executed, cause (at least one processor) to perform the operations according to some implementations of the present disclosure.

For the UE, processing device, computer readable (non-volatile) storage medium, and/or computer program product, the operations may include: receiving DCI triggering the CSI report; receiving a CSI-RS related to the CSI report; determining a PUCCH resource for the CSI report; and transmitting the CSI report based on the PUCCH resource. Determining the PUCCH resource for the CSI report may include determining, as the PUCCH resource for the CSI report, a PUCCH resource that does not start earlier than a point in time T+X and a point in time T′+Y among periodic PUCCH resources configured for the UE, where the point in time T is an end of the DCI, X is a minimum CSI computation time from the DCI reception, the point in time T′ is an end of the CSI-RS related to the CSI report, and Y is a minimum CSI computation time from the CSI-RS reception.

In some implementations, the PUCCH resource for the CSI report may be an earliest PUCCH resource occurring after the point in time T+X and the point in time T′+Y among PUCCH resources occurring based on a PUCCH resource periodicity and an offset included in a CSI configuration related to the CSI report.

In some implementations, the CSI report may be an A-CSI report.

In some implementations, the DCI may be DCI scheduling a PDSCH.

In some implementations, the DCI may include a PUCCH resource indicator and a PDSCH-to-HARQ_feedback indicator. Determining the PUCCH resource for the CSI report may include, based on that a first PUCCH resource determined based on the PUCCH resource indicator and the PDSCH-to-HARQ_feedback timing indicator does not start earlier than the point in time T+X and the point in time T′+Y, determining the first PUCCH resource as the PUCCH resource for the CSI report. Determining the PUCCH resource for the CSI report may include, based on that the first PUCCH resource starts earlier than the point in time T+X or the point in time T′+Y, determining, as the PUCCH resource for the CSI report, a second PUCCH resource occurring after the point in time T+X and the point in time T′+Y among the PUCCH resources occurring based on the PUCCH resource periodicity and the offset included in the CSI configuration related to the CSI report.

In some implementations, the minimum CSI computation time from the CSI-RS reception may be determined based on a CSI type included in the CSI report.

For reception of a CSI report, the BS may perform operations according to some implementations of the present disclosure. The BS may include: at least one transceiver; at least one processor; and at least one computer memory operably connected to the at least one processor and configured to store instructions that, when executed, cause the at least one processor to perform the operations according to some implementations of the present disclosure. A processing device for the BS may include: at least one processor; and at least one computer memory operably connected to the at least one processor and configured to store instructions that, when executed, cause the at least one processor to perform the operations according to some implementations of the present disclosure. A computer-readable (non-volatile) storage medium may be configured to store at least one computer program including instructions that, when executed by at least one processor, cause the at least one processor to perform the operations according to some implementations of the present disclosure. A computer program or computer program product may include instructions stored on at least one computer-readable (non-volatile) storage medium and, when executed, cause (at least one processor) to perform the operations according to some implementations of the present disclosure.

For the BS, processing device, computer readable (non-volatile) storage medium, and/or computer program product, the operations may include: transmitting DCI triggering the CSI report to the UE; transmitting a CSI-RS related to the CSI report; determining a PUCCH resource for the CSI report; and receiving the CSI report from the UE based on the PUCCH resource. Determining the PUCCH resource for the CSI report may include determining, as the PUCCH resource for the CSI report, a PUCCH resource that does not start earlier than a point in time T+X and a point in time T′+Y among periodic PUCCH resources configured for the UE, where the point in time T is an end of the DCI, X is a UE's minimum CSI computation time from the DCI reception, the point in time T′ is an end of the CSI-RS related to the CSI report, and Y is a UE's minimum CSI computation time from the CSI-RS reception.

In some implementations, the PUCCH resource for the CSI report may be an earliest PUCCH resource occurring after the point in time T+X and the point in time T′+Y among PUCCH resources occurring based on a PUCCH resource periodicity and an offset included in a CSI configuration related to the CSI report.

In some implementations, the CSI report may be an A-CSI report.

In some implementations, the DCI may be DCI scheduling a PDSCH.

In some implementations, the DCI may include a PUCCH resource indicator and a PDSCH-to-HARQ_feedback indicator. Determining the PUCCH resource for the CSI report may include, based on that a first PUCCH resource determined based on the PUCCH resource indicator and the PDSCH-to-HARQ_feedback timing indicator does not start earlier than the point in time T+X and the point in time T′+Y, determining the first PUCCH resource as the PUCCH resource for the CSI report. Determining the PUCCH resource for the CSI report may include, based on that the first PUCCH resource starts earlier than the point in time T+X or the point in time T′+Y, determining, as the PUCCH resource for the CSI report, a second PUCCH resource occurring after the point in time T+X and the point in time T′+Y among the PUCCH resources occurring based on the PUCCH resource periodicity and the offset included in the CSI configuration related to the CSI report.

In some implementations, the minimum CSI computation time from the CSI-RS reception may be determined based on a CSI type included in the CSI report.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

### INDUSTRIAL APPLICABILITY

The implementations of the present disclosure may be used in a BS, a UE, or other equipment in a wireless communication system.

1. A method of transmitting a channel state information (CSI) report by a user equipment (UE) in a wireless communication system, the method comprising:
receiving downlink control information (DCI) triggering the CSI report;
receiving a CSI reference signal (CSI-RS) related to the CSI report;
determining a physical uplink control channel (PUCCH) resource for the CSI report; and
transmitting the CSI report based on the PUCCH resource,
wherein determining the PUCCH resource for the CSI report comprises determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

2. The method of claim 1, wherein the PUCCH resource for the CSI report is an earliest PUCCH resource occurring after the time T+X and the time T′+Y among PUCCH resources occurring based on a PUCCH resource periodicity and an offset included in a CSI configuration related to the CSI report.

3. The method of claim 1, wherein the DCI is DCI scheduling a physical downlink shared channel (PDSCH).

4. The method of claim 2, wherein the DCI comprises a PUCCH resource indicator and a physical downlink shared channel to hybrid automatic repeat request feedback (PDSCH-to-HARQ_feedback) timing indicator,
wherein determining the PUCCH resource for the CSI report comprises:
based on a first PUCCH resource, determined based on the PUCCH resource indicator and the PDSCH-to-HARQ_feedback timing indicator, not starting earlier than the time T+X and the time T′+Y, determining the first PUCCH resource as the PUCCH resource for the CSI report; and
based on the first PUCCH resource starting earlier than the time T+X or the time T′+Y, determining, as the PUCCH resource for the CSI report, a second PUCCH resource occurring after the time T+X and the time T′+Y among the PUCCH resources occurring based on the PUCCH resource periodicity and the offset included in the CSI configuration related to the CSI report.

5. The method of claim 1, wherein the minimum CSI computation time from the CSI-RS reception is determined based on a CSI type included in the CSI report.

6. A user equipment (UE) configured to transmit a channel state information (CSI) report in a wireless communication system, the UE comprising:
at least one transceiver;
at least one processor; and
at least one computer memory operably connected to the at least one processor and configured to store instructions that, when executed, cause the at least one processor to perform operations comprising:
receiving downlink control information (DCI) triggering the CSI report;
receiving a CSI reference signal (CSI-RS) related to the CSI report;
determining a physical uplink control channel (PUCCH) resource for the CSI report; and
transmitting the CSI report based on the PUCCH resource,
wherein determining the PUCCH resource for the CSI report comprises determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.

7-10. (canceled)

11. A base station (BS) configured to receive a channel state information (CSI) report from a user equipment (UE) in a wireless communication system, the BS comprising:
at least one transceiver;
at least one processor; and
at least one computer memory operably connected to the at least one processor and configured to store instructions that, when executed, cause the at least one processor to perform operations comprising:
transmitting downlink control information (DCI) triggering the CSI report to the UE;
transmitting a CSI reference signal (CSI-RS) related to the CSI report;
determining a physical uplink control channel (PUCCH) resource for the CSI report; and
receiving the CSI report from the UE based on the PUCCH resource,
wherein determining the PUCCH resource for the CSI report comprises determining, as the PUCCH resource for the CSI report, a PUCCH resource that does not start earlier than a time T+X and a time T′+Y among periodic PUCCH resources configured for the UE, where a time T is an end of the DCI, X is a minimum CSI computation time from a DCI reception, a time T′ is an end of the CSI-RS related to the CSI report, and Y is a minimum CSI computation time from a CSI-RS reception.
